(19) United States
(12) Patent Application Publication
(10) Pub. No.: US 2026/0187912 A1
(43) Pub. Date: Jul. 2, 2026

(54) System and Method for Shadow Compensation during Digital Object Placement in Mixed Reality Environment

(71) Applicant: Flying Flamingos India Private Limited, Bangalore (IN)

(72) Inventors: Amit Gaiki, Bangalore (IN); Shourya Agarwal, Ajmer (IN); Avijit Kundal; Yaswanth NSN, Andhra Pradesh (IN)

(73) Assignee: Flying Flamingos India Private Limited, Bangalore (IN)

(21) Appl. No.: 19/435,969

(22) Filed: Dec. 30, 2025

(30) Foreign Application Priority Data
Dec. 30, 2024 (IN) 202441104502

(51) Int. Cl. G06T 15/60; G06T 7/50; G06V 10/77; G06V 10/82

(52) U.S. Cl. CPC G06T 15/60; G06T 7/50; G06V 10/7715; G06V 10/82

(57) ABSTRACT

The present disclosure provides a system and method for detecting and classifying shadows in a physical environment. The system includes one or more processors and a memory storing executable instructions. The system receives an image of a physical environment from one or more sensors of a user device, generates a depth map of the environment, and detects one or more shadow regions using a trained shadow detection model. The system classifies the image as a first or second shadow-type scene based on a generated shadow mask and the depth map. The system analyses light-ray distribution applies mathematical or HDRI-based estimation for light parameters, and maintains temporal coherence across sequential frames. The system outputs scene-classification data that triggers selection of a rendering or harmonization pipeline to ensure accurate lighting adaptation in mixed-reality environments.

### TECHNICAL FIELD

The present invention relates to the field of mixed-reality and computer-vision systems, and more particularly to a system and a method for detecting and classifying shadows in a physical environment in real time.

### BACKGROUND

Rapid advancement in mixed-reality (MR) and augmented-reality (AR) technologies has expanded the capability of user devices to perceive and interpret real-world environments. However, realistic visual blending of digital and physical components continues to depend heavily on accurate. The perception of realism in mixed-reality and augmented-reality environments relies heavily on accurate visual correspondence between digital and physical components of a scene. Specifically, the perception of realism relies heavily on estimation of lighting and shadow conditions within the user’s real-world surroundings. Small differences in lighting, shading, or shadow placement reduce visual coherence and realism in the rendered content.

Existing techniques for determining environmental lighting depend on average brightness measurements, sensor-based illumination readings, or fixed pre-configured parameters. These methods provide limited contextual understanding of how light interacts with surrounding objects and surfaces. In addition, these techniques often fail to identify directional cues in shadows. The shadows contain important information about light-source orientation, distance, and diffusion. Physical environment with varying lighting conditions make digital content adapt inaccurately to real-world scenes. The lack of reliable analysis of light behavior and shadow formation leads to frequent mismatches in tone, perspective, and spatial alignment between real and virtual elements.

In light of the above stated discussion, there exists a need for improved mechanisms that perceive and interpret lighting conditions in real time through better understanding of shadow behavior, light direction, and illumination intensity.

### SUMMARY

In an aspect, the present disclosure provides a system for detecting and classifying shadows in a physical environment in real time. The system includes one or more processors and a non-transitory memory storing instructions. The instructions, when executed by the one or more processors, cause the system to receive, from a user device, an image of a physical environment captured by one or more sensors. In addition, the one or more processors, cause the system to generate a depth map of the physical environment based on the image. Moreover, the one or more processors, cause the system to detect, using a shadow detection model trained to generate a shadow mask for the image, one or more shadow regions in the image. Further, the one or more processors, cause the system to generate, using the shadow detection model, the shadow mask corresponding to the detected shadow regions. Also, the one or more processors, cause the system to classify, using the shadow detection model, the image as at least one of a first shadow-type scene or a second shadow-type scene based on the generated shadow mask and the generated depth map. Furthermore, in response to the image being classified as the first shadow-type scene, the one or more processors cause the system to generate a three-dimensional representation of a shadow geometry using the generated depth map. The system estimates, using the shadow detection model and the generated depth map, a direction and intensity of a light source. In addition, the system outputs scene-classification data to the user device or a downstream rendering system. The scene classification data includes at least one of shadow type, the direction of the light source, the intensity of the light source, and a confidence score.

In an embodiment of the present disclosure, the classification includes analysing homogeneity or heterogeneity of light-ray distribution and luminance gradients across the physical environment to differentiate directional illumination from diffused illumination.

In an embodiment of the present disclosure, the system estimates lighting parameters using a mathematical light-vector computation for directional illumination and an HDRI-based environment-map analysis for non-directional illumination.

In an embodiment of the present disclosure, the system identifies indoor or outdoor illumination context based on lighting variance, shadow spread, and colour-temperature cues, and adjusts classification weighting accordingly.

In an embodiment of the present disclosure, the system processes sequential image frames and maintains temporal coherence of detected shadows to ensure consistent lighting adaptation in video sequences.

In an embodiment of the present disclosure, the system simultaneously classifies multiple shadow instances corresponding to multiple real or virtual objects in the scene.

In an embodiment of the present disclosure, the system outputs scene-classification data that triggers selection of a corresponding rendering or harmonization pipeline based on the determined illumination type.

In an embodiment of the present disclosure, the system performs distributed or server-side execution of sequential-frame analysis to optimize computation for resource-constrained devices.

In an embodiment of the present disclosure, classifying the image as the second shadow-type scene includes determining an absence of the generated shadow mask. The absence of the shadow mask is determined by performing a luminance homogeneity analysis across the image and analysing an absence of directional gradients in detected luminance values.

In an embodiment of the present disclosure, the shadow detection model is trained on a dataset of annotated synthetic images representative of different shadow conditions. The training of the shadow detection model includes extracting pixel-level luminance and chrominance features from the annotated synthetic images. In addition, the training includes generating ground-truth shadow masks for the annotated synthetic images. Further, the training includes optimizing model parameters based on a segmentation loss function that minimizes differences between predicted and ground-truth shadow masks.

In an embodiment of the present disclosure, optimizing the model parameters includes applying a multi-scale feature extraction strategy to preserve global shadow boundaries and fine-grained shadow details.

In an embodiment of the present disclosure, the shadow detection model includes a transformer-based segmentation network that performs pixel-level segmentation for generating the shadow mask.

In an embodiment of the present disclosure, generating the depth map includes estimating depth values using monocular depth estimation combined with a device-based spatial mapping framework that performs environmental depth estimation and coordinate anchoring.

In an embodiment of the present disclosure, estimating the direction of the light source includes computing a light vector from a tip of the detected shadow to a tip of a corresponding object in the three-dimensional representation of the scene.

In another embodiment of the present disclosure, estimating the direction of the light source includes calculating the intensity of the light source using pixel-level luminance analysis of the detected shadow region.

In an embodiment of the present disclosure, outputting the scene-classification data includes associating the data with a confidence score determined by a probability distribution output of the shadow detection model.

In an embodiment of the present disclosure, detecting the one or more shadow regions includes continuously receiving sequential frames from the user device and dynamically updating the shadow mask for each frame.

In an embodiment of the present disclosure, classifying the image includes distinguishing between one or more static environmental parameters and one or more dynamic environmental parameters. The one or more static environmental parameters include at least a surface geometry and object positions. The one or more dynamic parameters include lighting conditions and shadow regions.

In an embodiment of the present disclosure, the system distinguishes one or more first scenes classified as the first shadow-type scene caused by a single dominant light source from one or more second scenes classified as the second shadow-type scene caused by multiple ambient light sources.

In an embodiment of the present disclosure, generating the shadow mask includes refining pixel boundaries across multiple scales using a feature pyramid network to improve segmentation accuracy.

In an embodiment of the present disclosure, the confidence score represents a probability value that indicates a likelihood of correct shadow-type scene classification. The confidence score is calculated by applying a softmax function over feature embeddings of the image and used to determine a reliability threshold for accepting or rejecting the classification result.

In another aspect, the present disclosure provides a method for detecting and classifying shadows in a physical environment in real time. The method includes a first step of receiving, from a user device, an image of a physical environment captured by one or more sensors. The method includes a second step of generating, using one or more processors, a depth map of the physical environment based on the image. The method includes a third step of detecting, using a shadow detection model trained to generate a shadow mask for the image, one or more shadow regions in the image. The method includes a fourth step of generating, using the shadow detection model, the shadow mask corresponding to the detected shadow regions. The method includes a fifth step of classifying, using the shadow detection model, the image as at least one of a first shadow-type scene or a second shadow-type scene based on the generated shadow mask and the generated depth map. The method includes multiple steps executed in response to the image being classified as the first shadow-type scene. The multiple steps include a step of generating a three-dimensional representation of a shadow geometry using the generated depth map. The multiple steps include a subsequent step of estimating, using the shadow detection model and the generated depth map, a direction and intensity of a light source. The multiple steps include a final step of outputting scene-classification data to the user device or a downstream rendering system. The scene-classification data includes at least one of shadow type, the direction of the light source, the intensity of the light source, and a confidence score.

In an embodiment of the present disclosure, classifying the image as the first shadow-type scene or the second shadow-type scene is performed by jointly evaluating the generated shadow mask and the generated depth map to distinguish directional illumination from diffused illumination based on spatial consistency of shadow boundaries relative to depth discontinuities in the physical environment.

In yet another aspect, a non-transitory computer-readable medium is disclosed. The non-transitory computer-readable medium stores instructions that, when executed by one or more processors, cause a system to perform a method for detecting and classifying shadows in a physical environment in real time. The method includes a first step of receiving, from a user device, an image of a physical environment captured by one or more sensors. The method includes a second step of generating, using one or more processors, a depth map of the physical environment based on the image. The method includes a third step of detecting, using a shadow detection model trained to generate a shadow mask for the image, one or more shadow regions in the image. The method includes a fourth step of generating, using the shadow detection model, the shadow mask corresponding to the detected shadow regions. The method includes a fifth step of classifying, using the shadow detection model, the image as at least one of a first shadow-type scene or a second shadow-type scene based on the generated shadow mask and the generated depth map. The method includes multiple steps executed in response to the image being classified as the first shadow-type scene. The multiple steps include a step of generating a three-dimensional representation of a shadow geometry using the generated depth map. The multiple steps include a subsequent step of estimating, using the shadow detection model and the generated depth map, a direction and intensity of a light source. The multiple steps include a final step of outputting scene-classification data to the user device or a downstream rendering system. The scene-classification data includes at least one of shadow type, the direction of the light source, the intensity of the light source, and a confidence score.

### BRIEF DESCRIPTION OF DRAWINGS

Having thus described the disclosure in general terms, references will now be made to the accompanying figures, wherein:

FIG. 1 illustrates a schematic representation of an exemplary computing environment for detecting and classifying shadows in a physical environment, in accordance with various embodiments of the present disclosure;

FIG. 2 illustrates a block diagram of functional modules of a system for detecting and classifying shadows in a physical environment, in accordance with various embodiments of the present disclosure;

FIG. 3 illustrates a flowchart depicting a method for detecting and classifying shadows in a physical environment in real time, in accordance with various embodiments of the present disclosure; and

FIG. 4 illustrates an exemplary computing environment suitable for implementing a system for detecting and classifying shadows in a physical environment, in accordance with various embodiments of the present disclosure.

It should be noted that the accompanying figures are intended to present illustrations of exemplary embodiments of the present disclosure. The figures are not intended to limit the scope of the present disclosure. It should be noted that accompanying figures are not necessarily drawn to scale.

### DETAILED DESCRIPTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word "may" is used in a permissive sense (i.e. meaning having the potential to), rather than the mandatory sense, (i.e. meaning must). Further, the words "a" or "an" mean "at least one” and the word “plurality” means “one or more” unless otherwise mentioned. Furthermore, the terminology and phraseology used herein is solely used for descriptive purposes and should not be construed as limiting in scope. Language such as "including," "comprising," "having," "containing," or "involving," and variations thereof, is intended to be broad and encompass the subject matter listed thereafter, equivalents, and additional subject matter not recited, and is not intended to exclude other additives, components, integers, or steps. Likewise, the term "comprising" is considered synonymous with the terms "including" or "containing" for applicable legal purposes. Any discussion of documents, acts, materials, devices, articles, and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. The values and ranges are to be treated as examples only, and are not intended to limit the scope of the claims. In addition, a number of system architectures are identified as suitable for various facets of the implementations. The system architectures are to be treated as exemplary and are not intended to limit the scope of the invention.

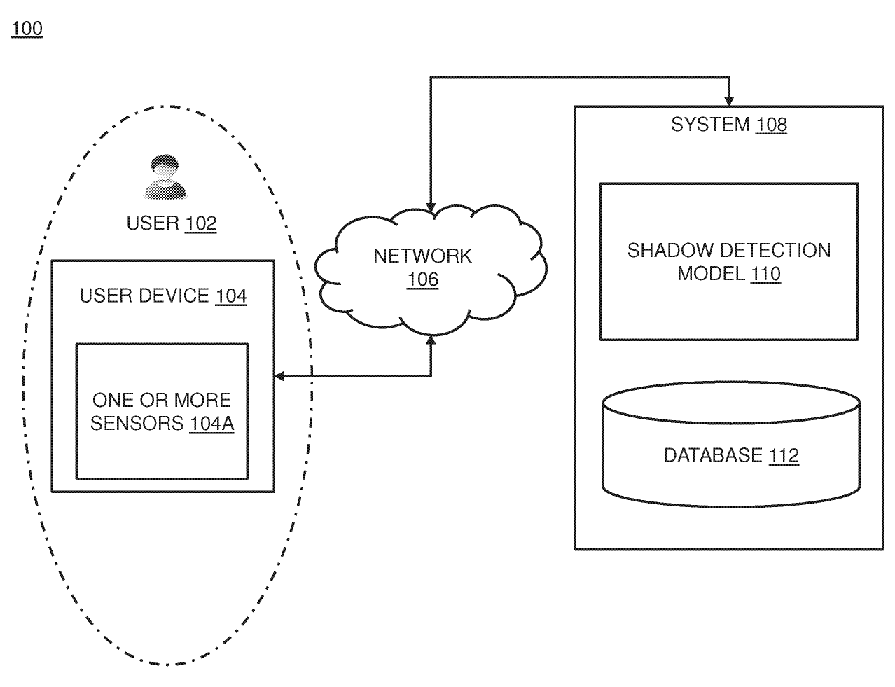

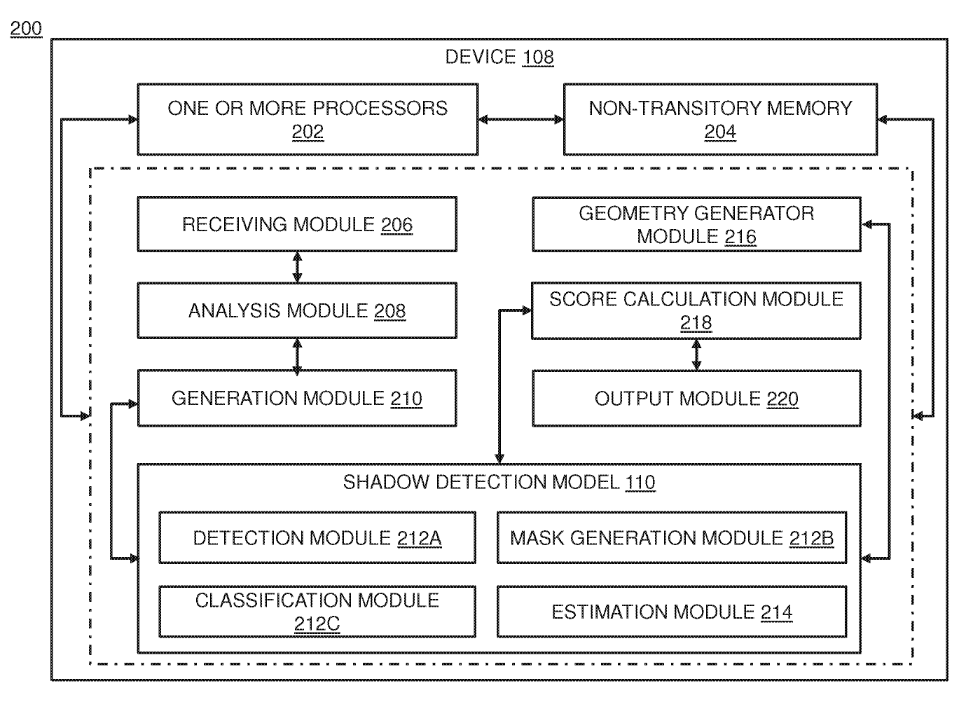

FIG. 1 illustrates a schematic representation of an exemplary interactive computing environment 100 for real-time shadow detection and classification, in accordance with various embodiments of the present disclosure. The computing environment 100 supports downstream harmonization and rendering operations. The environment 100 may include a user device 104 equipped with one or more sensors 104a, a network 106, and a system 108. The system 108 includes a shadow detection model 110 and a database 112 and optional edge or cloud compute resources. The components operate cooperatively to capture image and sensor data, transmit the data across network paths, analyse lighting and shadow characteristics, and store relevant artifacts. Accordingly, the components provide scene-classification outputs and harmonization assets for rendering virtual objects for digital content alignment with real-world illumination. The interactive computing environment 100 supports end-to-end cycle from capture to analysis to rendering. In addition, the computing environment 100 enables both on-device and distributed execution depending on implementation needs.

The physical environment represents any real-world space surrounding a user, including outdoor settings such as streets, parks, and plazas, and indoor settings such as homes, studios, industrial sites, or public venues. The physical environment includes natural and artificial light sources, for example sunlight, skylight, lamps, LEDs, fluorescents, and reflected illumination from nearby surfaces. The environment includes physical objects that occlude light and generate shadows, including static structures (walls, floors, furniture) and dynamic entities (people, vehicles, foliage). Surface properties such as texture, reflectivity, color, and material composition influence shadow characteristics; polished surfaces produce different shadow contrast compared to rough or matte surfaces. The interactive computing environment continually observes such variations. The variations may include time-of-day effects, weather changes, and user motion, to ensure that captured imagery remains contextually valid for shadow analysis and subsequent photometric alignment.

Further, the physical environment includes spatial and contextual metadata that the system 108 utilises to refine interpretation of lighting. Such metadata may include geographical coordinates, ambient temperature proxies, or time stamps that help the system 108 infer likely illumination conditions (for example sun azimuth for a given time and location). In certain embodiments, the system 108 differentiates scenes as indoor or outdoor and adjusts parameter weighting accordingly, for instance by giving greater emphasis to directional light estimation outdoors where sunlight often dominates, and by prioritising HDRI-like ambient mapping indoors where multiple diffused sources influence lighting. The contextual awareness assists the classification logic in selecting an appropriate estimation strategy for subsequent rendering pipelines.

The system 108 recognises that physical environments may contain multiple concurrent light sources and complex inter-reflections. Accordingly, the environment representation includes notions of dominant and ambient sources, and the system 108 tags observed lighting as hard (single dominant directional source) or soft (multiple diffused sources). The system 108 records changes in environmental illumination such as flicker from artificial sources or transient occlusions (e.g., passing vehicles or moving people). These observations inform temporal-smoothing mechanisms, confidence evaluation, and decision logic that control whether to apply immediate reclassification, buffer for temporal aggregation, or trigger downstream harmonization updates.

The user 102 represents an individual who interacts with the system 108 through the user device 104 to experience real-time illumination analysis and mixed-reality rendering. The user initiates or participates in a session either explicitly or automatically. Explicit initiation occurs, for instance, when the user opens an application, selects an activation link, or scans a marker that triggers the mixed-reality or lighting-analysis workflow. Automatic initiation may occur through contextual triggers such as geolocation detection, object recognition, or changes in ambient lighting captured by the sensors. Once activated, the user device 104 begins continuous acquisition of images and sensor data representing the physical environment, which the system processes to determine shadow presence, light-source direction, and related parameters.

The user device 104 acts as the primary interface and data-capture component in the environment. The user device 104 includes processing hardware, memory, communication interfaces, and a set of sensors configured to collect imagery and environmental data. Examples of the user device 104 include smartphones, tablets, laptops, augmented-reality (AR) headsets, smart glasses, or other wearable computing systems capable of recording high-resolution frames of the physical scene. The user device 104 may execute some pre-processing functions locally, such as frame normalization, noise filtering, or feature encoding, to reduce transmission load and latency. In some configurations, the device performs partial inference using an embedded model and transmits compact descriptors to the system for refinement.

The user device 104 operates as both a capture instrument and a display platform. The user device 104 renders visual content enhanced by illumination parameters produced by the system. The display may present digital objects, overlays, or analytic visualizations that appear consistent with real-world lighting. For example, when a digital 3D object is placed onto a surface in the user’s field of view, the rendered shadow orientation and brightness correspond to the light direction and intensity determined from the captured scene. The user may perceive the result as photometrically coherent, creating a natural blend between real and virtual elements.

The one or more sensors 104a integrated into the user device 104 capture multimodal data streams that describe the surrounding environment. The sensors include an RGB or multispectral camera for color imagery, a depth sensor or LiDAR unit for distance estimation, an inertial measurement unit (IMU) for motion tracking, a photometric sensor for ambient brightness, and optionally a proximity or thermal sensor for contextual awareness. The one or more sensors 104a operate synchronously to generate a combined dataset that represents both visual and spatial characteristics of the scene. The synchronization ensures that the color and depth data correspond to the same moment in time, which is critical for reliable shadow localization and geometric alignment.

In an embodiment, the one or more sensors 104a record metadata associated with each frame, including camera orientation, focal length, aperture setting, exposure duration, and white-balance parameters. The metadata allows the system to reconstruct the camera’s viewpoint and compensate for optical differences between devices. For example, if two different users capture the same object under similar lighting conditions but with different camera lenses, the system 108 uses calibration data to normalize the imagery before analysis. In some implementations, the IMU readings are fused with image data to stabilize the perceived geometry when the user moves the device, preserving temporal coherence of shadow interpretation.

The communication network 106 connects the user device 104 and the system 108. and supports bidirectional transmission of captured data, intermediate results, and classification outputs. The network may include wired or wireless channels such as 4G, 5G, Wi-Fi, or next-generation communication standards, and may be implemented as an Internet, intranet, or hybrid structure combining edge and cloud nodes. The network provides sufficient bandwidth and low latency to enable real-time illumination analysis. Security features such as encryption, authentication, and packet integrity verification ensure that transmitted data remains protected. The system 108 employs compression and adaptive bandwidth allocation strategies to optimize throughput, especially when transmitting high-resolution frames or sequential video streams for continuous analysis.

In certain embodiments, the network 106 incorporates edge-computing nodes located near the user device 104 to perform preliminary pre-processing before forwarding data to the central system. Such edge nodes may perform exposure normalization, frame filtering, or early inference to reduce computational load on the cloud and minimize latency. The network supports hybrid operation modes in which local device inference runs in parallel with cloud refinement. For instance, a local model may provide immediate frame-by-frame classification for responsiveness, while the server-based system periodically updates the parameters with higher accuracy derived from aggregated analysis of multiple frames.

The system 108 serves as the central processing and orchestration component of the interactive computing environment. The system 108 receives visual and sensor data captured by the user device 104 through the network 106, analyses the data using a combination of machine-learning and deterministic techniques, and generates illumination and shadow-related outputs. The system 108 may be implemented as an on-device framework, an edge node, a cloud-based processing service, or a distributed combination of these. The modular architecture of the system 108 allows dynamic distribution of computational workloads based on latency, device capability, and network conditions.

The system 108 includes hardware resources such as one or more processors, high-speed memory, storage units, and communication interfaces. The processors may include graphics processing units (GPUs) or tensor processing units (TPUs) for accelerating neural-network inference. The memory stores model parameters, intermediate feature maps, and scene metadata. The communication interfaces enable simultaneous data exchange with multiple user device 104s or edge nodes. The system 108 operates as a closed-loop framework, meaning that analysis results from one frame inform parameter adjustments for subsequent frames, ensuring temporal consistency across continuous video streams.

The system 108 comprises several logical modules, including a data-ingestion interface, a pre-processing module, a depth-estimation unit, a system 108, a metadata extractor, and a result-distribution interface. The data-ingestion interface synchronizes color, depth, and orientation data arriving from the user device 104 to maintain geometric and temporal alignment. The pre-processing module standardizes brightness, performs noise reduction, and converts imagery into a luminance–chrominance representation. The depth-estimation unit refines spatial understanding of the captured scene by integrating monocular cues with LiDAR or stereo data when available. These foundational modules prepare the dataset for downstream shadow detection and classification by the shadow detection model 110.

The shadow detection model 110 represents a trained computational model capable of performing pixel-level segmentation to detect and classify shadow regions within an input frame. The shadow detection model 110 may be implemented using a convolutional neural network, a transformer-based segmentation network, or a hybrid architecture optimized for both accuracy and efficiency. During operation, the shadow detection model 110 receives the pre-processed image and corresponding depth map and generates a shadow mask identifying shaded and illuminated regions. The model calculates auxiliary outputs such as confidence scores, gradient fields, and feature embeddings that support classification tasks, including determination of light-source direction and diffusion type.

In certain embodiments, the shadow detection model 110 is trained on a composite dataset containing both real and synthetic images annotated with shadow masks, depth information, and light-source parameters. The dataset encompasses a wide variety of conditions, including outdoor sunlight, indoor artificial lighting, and mixed-illumination environments. The model training process uses loss functions designed to preserve both global shadow boundaries and fine-grained edge details. Once trained, the shadow detection model 110 operates in real time to process sequential frames, adapting dynamically to variations in illumination and scene composition.

The system 108 includes a database 112, which acts as a structured repository for storing image datasets, trained model parameters, feature embeddings, and output metadata. The database 112 may use relational or non-relational structures depending on scalability requirements. In one implementation, the database 112 stores annotated samples used for retraining or fine-tuning the shadow detection model 110, while in another, the database 112 maintains logs of environmental lighting analyses and their corresponding timestamps for temporal tracking. The database 112 may store configuration profiles, performance metrics, and user-device calibration parameters that enable consistent operation across heterogeneous hardware.

The database 112 communicates bi-directionally with the shadow detection model 110 and other modules of the system 108. The database 112 supplies model weights, calibration data, and training samples to the model during initialization or retraining, and in return, receives and archives newly generated feature embeddings and confidence distributions from ongoing inference sessions. The feedback exchange allows continuous improvement and adaptation of the model to evolving environmental conditions or sensor characteristics.

In an embodiment, the database 112 is distributed across multiple storage nodes to ensure redundancy and high availability. The database architecture may include a model repository for maintaining versioned model weights, a real-time cache for storing recent inference results, and a long-term archive for preserving historical illumination records. The database 112 uses indexing and metadata tagging to facilitate rapid retrieval of prior lighting contexts when ehvaluating similar scenes in future sessions, thhtereby improving response time and stability.

The system 108, the shadow detection model 110, and the database 112 together establish an intelligent analytical framework capable of understanding and classifying shadows within complex environments. The system 108 integrates data acquisition, real-time analysis, and structured storage into a cohesive architecture. The outputs produced, such as shadow masks, illumination vectors, and classification confidence scores, form the basis for rendering modules that harmonize digital content with the physical environment, ensuring that virtual objects remain visually coherent under dynamically changing lighting conditions.

The system 108 communicates with the user device 104 and the network 106 to establish a continuous, bidirectional flow of data that enables real-time illumination and shadow analysis. The user device 104 captures visual frames, depth data, and contextual parameters that describe the current physical environment. The system 108 receives these inputs and performs high-speed computation to identify and classify shadows, estimate illumination direction, and assess the consistency of detected features across time. The results are transmitted back to the user device 104 or to the associated rendering frameworks for visual integration. The continuous exchange ensures that digital and physical elements remain photometrically synchronized during dynamic user interactions.

The operational flow of the system 108 involves data acquisition, normalization, analysis, and output distribution. The data-acquisition interface collects image and sensor streams, while the pre-processing module removes noise and compensates for exposure variations. The shadow detection model 110 executes shadow segmentation and classification on the processed frame, producing both visual masks and quantitative illumination descriptors. These descriptors are then aggregated, validated for confidence and consistency, and stored temporarily within the database 112. The result-distribution interface forwards refined lighting parameters to client-side modules responsible for harmonizing or rendering digital content in the physical scene.

The system 108 maintains temporal coherence by analysing frame sequences rather than isolated images. For each new frame, the system 108 compares the current shadow mask and lighting estimates with corresponding data from recent frames stored in the database 112. When the system 108 detects a significant change in light intensity, direction, or shadow geometry, the system 108 triggers an adaptive reclassification process. The temporal approach minimizes flicker and instability in lighting interpretation, ensuring smooth transitions in illumination analysis even under rapidly varying conditions such as moving clouds, user motion, or artificial light flicker.

The system 108 integrates an edge-synchronization layer that maintains alignment between locally processed and remotely processed data streams. For instance, when a user device 104 performs partial inference on captured frames and transmits compact descriptors rather than raw images, the edge-synchronization layer ensures that these descriptors correspond exactly to the frames stored in the database 112. The synchronization supports hybrid deployments in which both on-device and cloud components contribute to the overall illumination analysis pipeline.

The data orchestration framework within the system 108 manages prioritization and scheduling of concurrent analysis tasks. In a scenario involving multiple user devices, each device generates an independent data stream representing a unique physical environment. The orchestration framework dynamically allocates computational resources, assigns priority levels based on scene complexity or network latency, and balances processing loads across available processors. The design enables the system 108 to maintain consistent response times even under high user concurrency.

The database 112 includes a lighting-parameter repository. The lighting-parameter repository maintains historical illumination trends derived from prior analyses. For every analysed scene, the repository records timestamped light-source parameters, confidence scores, and classification outcomes. The historical records allow the system 108 to detect long-term variations in lighting conditions and to forecast potential future trends. For example, if repeated frames show a gradual shift in dominant light direction, the system 108 pre-emptively adjusts its classification criteria or model weights to match the evolving scene dynamics.

The shadow detection model 110 interacts continuously with both the database 112 and the system 108 within the system 108. The model reads stored calibration data and training weights, performs inference on incoming frames, and writes updated feature embeddings back to the database. The closed feedback loop ensures that the system 108 maintains analytical consistency across sessions and devices, providing uniform lighting estimation performance regardless of hardware variations or environmental diversity.

While FIG. 1 illustrates a single user 102 interacting with a single user device 104, multiple users may simultaneously interact with respective devices operating within distinct physical environments. Each user device independently executes the shadow detection and classification operations and may share contextual parameters such as the detected shadow masks, light-direction vectors, or illumination metadata with the system 108 through the network 106.

The number and arrangement of systems, devices, and networks shown in FIG. 1 are merely illustrative. Additional computing nodes, sensors, or processing entities may be integrated, or certain modules may be consolidated depending on implementation scenarios. For example, some embodiments execute all analysis modules on the user device 104, while others employ distributed architectures where the shadow detection model 110 and estimation logic operate on edge or cloud servers. Such architectural flexibility enables the interactive computing environment 100 to scale across mobile devices, AR glasses, tablets, or server-assisted mixed reality setups while maintaining real-time detection and classification performance.

Beyond these configurations, the system 108 is operable to execute shadow analysis pipelines that fuse sensor data streams with illumination estimation models. In one embodiment, the RGB image data and depth sensor information are jointly processed to refine shadow boundaries, compute shadow–light correspondences, and enhance the reliability of illumination inference. The fusion process ensures accurate distinction between genuine shadows and dark object textures, improving scene interpretability and providing robust input for downstream rendering or harmonization processes.

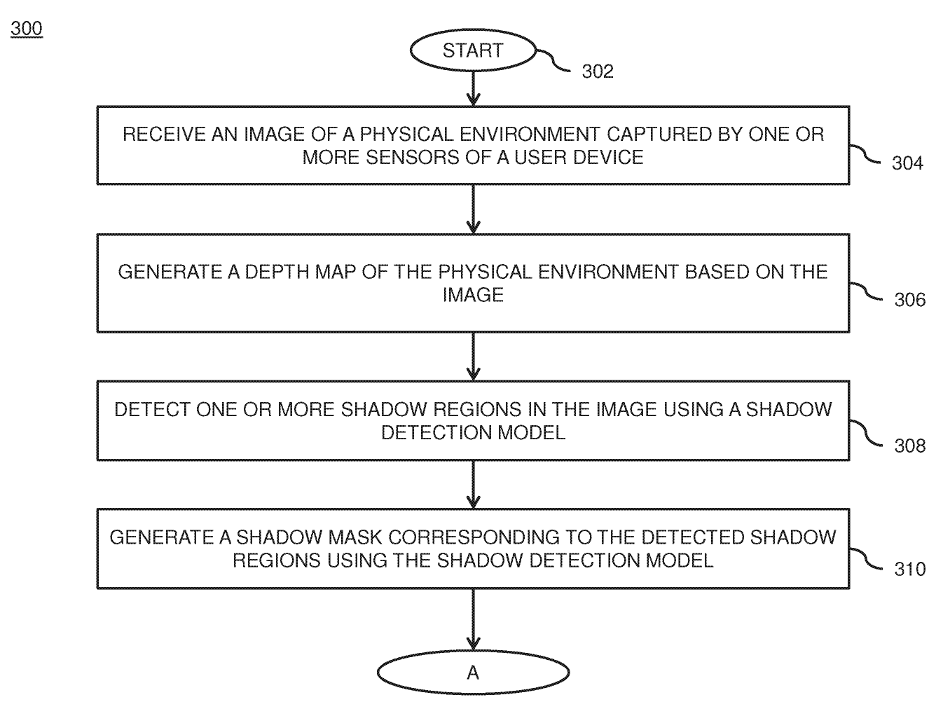

FIG. 2 illustrates a block diagram 200 of the system 108 for detecting and classifying the shadows in the physical environment in real time, in accordance with various embodiments of the present disclosure. The figure shows the internal system modules and the data flow relationships that collectively enable the system 108 to receive image data, generate depth information, detect shadow regions, classify lighting conditions, and output illumination-related parameters.

The system 108 includes one or more processors 202 operatively coupled to a non-transitory memory 204. The non-transitory memory 204 stores executable instructions that, when executed by the one or more processors 202, cause the system 108 to perform real-time image analysis and environmental lighting interpretation. The one or more processors 202 execute these program instructions to process image data captured by the one or more sensors 104a of the user device 104. The processors analyse the incoming frames, generate shadow masks, classify scenes into pre-defined shadow types, and estimate directional illumination cues. References to the elements of FIG. 1 are made throughout The section for clarity and coherence.

The system 108 includes a modular processing pipeline executed by the one or more processors 202. The pipeline consists of a sequence of specialized modules designed to process environmental data in a logically ordered and feedback-driven manner. The modules include a receiving module 206, an analysis module 208, a generation module 210, a detection module 212a, a mask generation module 212b, and a classification module 212c. In addition, the modules include an estimation module 214, a geometry generator module 216, a score calculation module 218 and an output module 220. The above-mentioned modules are exemplary and non-limiting. In certain implementations, additional or alternative modules may be incorporated within the system 108 to accommodate diverse deployment scenarios or environmental complexities.

The plurality of system modules are operatively coupled in a structured workflow that enables continuous data flow and adaptive feedback between modules. Each module produces outputs that serve as standardized inputs for subsequent modules, maintaining a consistent data representation throughout the analysis pipeline. The interconnection of modules ensures that the shadow detection and classification process proceeds sequentially, from image acquisition to illumination estimation. The module interaction allows real-time re-evaluation when environmental lighting changes are detected.

The elements of the system 108 described herein are operatively coupled to enable end-to-end environmental analysis for illumination understanding. The one or more processors 202 orchestrate the operation of these modules by executing program instructions stored in the non-transitory memory 204. The execution flow begins with reception of image and sensor data from the user device 104 and proceeds through depth estimation, shadow detection, classification, and light parameter generation. Each module operates either independently or cooperatively with adjacent modules depending on runtime conditions, resource availability, and environmental complexity.

The memory 204 stores instructions that enable dynamic, adaptive analysis of the lighting conditions in real time. The processors 202 are operably coupled with the receiving module 206, the analysis module 208 and the generation module 210. Also, the one or more processors 202 are operably coupled to the detection module 212a, a mask generation module 212b, and a classification module 212c. In addition, the one or more processors are operably coupled to the geometry generator module 216, the estimation module 214, the score calculation module 218 and the output module 220. The modules collectively operate to maintain a low-latency analytical pipeline optimized for continuous operation.

The components of the system 108 operate in synchronization to enable the user 102 to experience a contextually accurate visualization or analytical output that reflects the actual lighting conditions of the environment. The system 108 functions within a distributed computing environment that includes the user device 104, one or more edge servers hosting the shadow detection model 110, and the cloud database 112. The distributed configuration allows real-time updates to model parameters and ensures consistency of shadow interpretation across multiple devices.

Each module of the system 108 is designed to be independently deployable and replaceable without disrupting the overall operation. The modular structure provides extensibility and adaptability to future system updates, sensor enhancements, or advanced model versions. The system 108 functions as a scalable and reconfigurable analytical platform capable of supporting diverse lighting-analysis requirements in real-world environments.

The receiving module 206 receives, from the user device 104, an image of the physical environment captured by one or more sensors 104a embedded in the user device 104. In an embodiment, the one or more sensors 104a include at least one of an RGB camera, a depth sensor, a LiDAR module, or an illumination sensor. The receiving module 206 manages acquisition of raw visual data streams along with sensor metadata such as timestamp, exposure, and device orientation.

The receiving module 206 performs initial validation checks on all incoming data to ensure completeness and reliability. These checks include verification of frame integrity, checksum validation, and timestamp synchronization across multiple data channels. When the system receives out-of-sequence or corrupted packets, the receiving module 206 automatically re-orders or discards such frames to preserve continuity. The receiving module 206 annotates each valid frame with a standardized metadata header that includes a unique frame identifier, capture timestamp, camera intrinsic parameters such as focal length and principal point, and device pose information when available. The metadata standardization ensures consistent interpretation by all downstream modules, regardless of variations in hardware or capture conditions.

In an embodiment of the present disclosure, the receiving module 206 performs lightweight preprocessing based on network or device constraints. Example operations include image downscaling to a fixed inference resolution, adaptive compression with luminance-preserving parameters, and extraction of device-computed descriptors such as global exposure, median luminance, and coarse surface normals. These descriptors serve as compact representations of the captured scene, allowing the system 108 to maintain robust shadow analysis even under constrained bandwidth.

The receiving module 206 performs frame prioritization based on motion intensity derived from IMU data. For instance, when the user device 104 undergoes rapid movement, the module dynamically adjusts the frame acquisition rate to prevent redundant data capture. The validated and pre-processed frames, along with their associated metadata, are forwarded to the analysis module 208 for feature extraction. Simultaneously, the receiving module 206 stores a temporary copy in the data-management buffer to support short-term temporal comparisons, reprocessing, or frame re-requests in case of data corruption.

In another embodiment, the receiving module 206 employs secure transmission protocols and data encryption to protect captured imagery and sensor information during network transfer. The secure communication framework ensures privacy preservation and integrity verification of all environmental data transmitted between the user device 104 and the shadow-analysis system 108.

The analysis module 208 analyzes the received image of the physical environment to extract one or more features representative of lighting, texture, and spatial composition. In an embodiment, the analysis module 208 performs pixel-level statistical analysis, edge detection, and chromatic segmentation to identify contrast gradients and reflectance properties of surfaces. The term feature refers to a numerical descriptor quantifying observable characteristics within the image such as brightness, orientation, or saturation. The analysis module may employ machine-learning techniques such as convolutional feature extractors or handcrafted operators (e.g., Sobel or Laplacian filters) to compute illumination and texture features. The extracted features serve as intermediate representations for generating a depth map and detecting shadows in subsequent modules.

The analysis module 208 first converts the input image into a standardized color space such as YCbCr or linear RGB to decouple luminance (brightness information) from chrominance (color information). The separation allows the system 108 to analyze brightness variations independently of color variations, a critical distinction because shadows often alter luminance while leaving chromaticity largely unchanged. The module then applies bilateral filtering or equivalent noise-reduction techniques to suppress sensor noise without blurring important edges.

In an embodiment of the present disclosure, the analysis module 208 constructs multi-scale image pyramids that represent the same scene at progressively reduced resolutions. Each scale captures different illumination characteristics, coarse scales emphasize global brightness patterns, while fine scales highlight local shadow boundaries. The module computes per-pixel gradients using operators such as Sobel or Scharr filters, or using learned gradient features obtained through shallow convolutional layers. These gradients reveal abrupt luminance transitions typically associated with shadow edges.

The analysis module 208 computes chromaticity-invariant features to distinguish shadows from dark-colored materials. The term chromaticity-invariant refers to image features that remain stable under color shifts and primarily respond to changes in intensity rather than hue. Since genuine shadows tend to preserve color ratios even when brightness decreases, these invariant features enable the system 108 to differentiate true shadow regions from dark textured surfaces.

In an embodiment of the present disclosure, the analysis module 208 computes motion-compensated frame differences across consecutive frames when temporal data is available. The module uses IMU (inertial measurement unit) data to align frames spatially before comparison. The IMU data includes accelerometer and gyroscope readings that describe device motion and orientation. Motion compensation ensures that observed luminance changes result from lighting variation rather than camera movement, preventing false shadow detections.

The analysis module 208 produces a composite feature tensor that integrates multiple types of derived data: normalized luminance maps, chromaticity maps, multi-scale gradient maps, temporal difference maps, texture descriptors such as local binary patterns, and an uncertainty map. The uncertainty map quantifies confidence at each pixel based on factors such as motion blur, sensor noise, and exposure range, allowing later modules to weight each region appropriately during analysis.

For example, when the system analyzes an outdoor scene at dusk, the analysis module 208 converts the input image into linear RGB, applies a three-level image pyramid, and computes luminance gradients that isolate sharp shadow edges cast by lampposts. In the same process, the analysis module 208 generates an uncertainty map marking underexposed regions, two stops below normal exposure, where detection confidence is reduced and validation is required.

In an embodiment of the present disclosure, the analysis module 208 computes spatial statistics over localized regions to quantify the homogeneity or heterogeneity of light distribution. The term homogeneity refers to uniform luminance across a surface, while heterogeneity represents strong directional illumination variations. The module calculates the mean and variance of luminance values within 16 × 16 pixel patches, and applies oriented derivative filters to detect dominant gradient directions. A high directional variance with elongated, coherent gradient vectors indicates directional (hard) lighting, while low variance and isotropic gradients indicate diffused (soft) illumination.

The system 108 stores all computed metrics in the feature tensor and forwards them to subsequent modules such as the generation module 210 and the classification module 212c. These feature descriptors significantly enhance the differentiation between first-type (directional) and second-type (diffused) shadow scenes, forming the analytical foundation for accurate real-time lighting interpretation.

The generation module 210 generates, using one or more processors, a depth map of the physical environment based on the image. In an embodiment, the generation module 210 computes per-pixel distance values that represent spatial geometry relative to the imaging plane. The term depth map refers to a two-dimensional array in which each pixel intensity corresponds to an estimated distance from the camera to a surface point in the environment. The generation module 210 may use stereo disparity computation, structured-light projection, or monocular depth-estimation networks such as MiDaS for scenes lacking depth sensors. The generated depth map forms the geometric foundation for determining object boundaries, occlusions, and potential shadow regions.

The generation module 210 produces a per-pixel depth estimate (the depth map) that associates each image pixel with an approximate real-world distance along the camera ray. The module implements multiple strategies depending on input availability. The multiple strategies include a first strategy, a second strategy and a third strategy. According to the first strategy, the module, upon presence of a direct depth sensor or LiDAR data, ingests the point cloud, performs outlier removal, and projects into the image plane. According to the second strategy, the module, upon availability of only monocular RGB, runs a monocular depth estimator (a trained neural network) that predicts relative depth from single images using learned priors. According to the third strategy, the module, in hybrid cases, fuses sparse LiDAR points with monocular depth via a guided upsampling algorithm to produce dense, accurate depth maps.

The sensor fusion refers to a computational process that integrates heterogeneous sensor data to achieve a more accurate and stable representation than any single sensor could provide independently. The generation module 210 applies a probabilistic or Bayesian weighting framework to perform The fusion. Where LiDAR or structured-light data provides valid measurements, the module prioritizes those readings; where such data is sparse or unavailable, monocular depth prediction serves as a prior. The fusion algorithm minimizes a smoothness-constrained objective function, which balances geometric fidelity and continuity by reducing both reprojection error and depth irregularity.

In an embodiment of the present disclosure, the generation module 210 computes surface normals derived from local depth gradients to represent the orientation of surfaces relative to the light source. A surface normal is a three-dimensional vector perpendicular to a surface patch, used extensively in illumination modeling and rendering. The module generates a confidence map that quantifies the reliability of depth estimation at each pixel. The confidence values are propagated downstream to prevent over-reliance on low-confidence depth regions during shadow segmentation and light-direction estimation.

For example, when operating on a smartphone that lacks LiDAR hardware, the generation module 210 produces a relative depth map using monocular estimation. In such a case, a person’s torso may exhibit a higher depth value (closer distance) than the background wall. The generation module 210 refines these depth estimates using IMU readings to correct parallax errors caused by minor camera motion and to stabilize the depth map across sequential frames. The module assigns higher confidence to static regions such as the floor or walls, while assigning lower confidence to regions exhibiting motion or poor texture.

In an embodiment of the present disclosure, the generation module 210 combines monocular depth estimation with a device-based spatial mapping framework for environmental coordinate anchoring. The term spatial mapping refers to the process of constructing a 3D model of the user’s environment by correlating visual and motion data. The system 108 employs IMU-based motion cues and ARKit/ARCore-style spatial anchors to convert relative monocular depths into metric-scale values. When occasional absolute depth samples (for example, from a brief LiDAR sweep) are available, the fusion algorithm aligns the monocular depth scale to these anchor points using Procrustes or scale-and-translation transformations. The calibration process enables accurate 3D reconstruction of shadow-casting geometries and ensures consistent depth scaling across multiple frames and sensors.

The generation module 210 consolidates the photometric features extracted by the analysis module 208 with the depth outputs into a unified tensor representation expected by the shadow detection model 110. The term tensor refers to a multi-dimensional array of numerical values representing structured data inputs to a neural network. The module performs per-channel normalization, constructs multi-scale feature pyramids, encodes depth information as an additional input channel, and embeds positional encodings to support transformer-based segmentation architectures.

In an embodiment of the present disclosure, the generation module 210 implements dynamic batching mechanisms to group frames based on shared inference resolution or identical camera intrinsics. The grouping improves GPU utilization and reduces inference latency during large-scale shadow analysis. The module optimizes memory layout (for example, channel-major ordering) to minimize cache misses and enhance throughput during neural inference operations.

The output of the generation module 210 includes the finalized depth map, the associated confidence map, and spatially registered geometric information, all of which are forwarded to the detection module 212a for identifying shadow regions.

The shadow detection model 110 constitutes the AI core. The shadow detection model 110 may implement a hybrid architecture combining a multi-scale encoder-decoder with transformer-based attention for global context. The model exposes four logical submodules: the detection module 212a (coarse candidate localization), the mask generation module 212b (pixel-accurate segmentation), the classification module 212c (scene-type classification), and the estimation module 214 (lighting parameter regression). Each submodule returns both deterministic outputs and uncertainty estimates.

The shadow detection model 110 detects, using a trained artificial intelligence model, one or more shadow regions within the image of the physical environment received from the generation module 210. The shadow detection model 110 operates as a deep learning-based segmentation framework trained to identify and delineate shadows at the pixel level. The generation module 210 may incorporate a hybrid encoder–decoder architecture with attention-based enhancements to achieve both global illumination awareness and fine-grained spatial precision.

The shadow detection model 110 employs a multi-scale convolutional encoder backbone configured to extract hierarchical feature representations from input images. The encoder comprises residual blocks that maintain gradient stability during training and dilated convolutions that expand the receptive field without compromising resolution. The expansion enables the model to simultaneously capture local edge transitions and global contextual lighting relationships. To improve representational depth, the model uses a feature pyramid network (FPN) that merges low-level spatial detail from earlier convolutional layers with high-level semantic abstractions from deeper layers. The FPN structure enhances shadow-edge fidelity by preserving boundary sharpness even under soft or partially occluded lighting conditions.

The encoder is integrated with a transformer module designed to model long-range dependencies and scene-level relationships. The transformer module receives flattened patch embeddings generated from the encoder output and applies multi-head self-attention to establish global context awareness. The term self-attention refers to the process by which each pixel or patch representation dynamically adjusts an associated importance based on correlations with all other regions in the frame. The mechanism allows the model to disambiguate shadows cast across large or complex environments where local luminance cues alone are insufficient, such as overlapping shadows from multiple light sources.

The decoder portion of the model performs the upsampling of transformer-enhanced feature maps through skip connections that restore fine spatial resolution. The decoder outputs per-pixel logits representing the probability of each pixel belonging to a shadow or illuminated region. These logits are later converted into binary or confidence-weighted masks that indicate the presence and confidence level of shadow detection.

The training of the shadow detection model 110 is carried out on a large and carefully curated dataset comprising both real-world and synthetically rendered images. The real images encompass indoor and outdoor scenes captured under diverse weather conditions, times of day, and lighting environments, ensuring robust generalization across natural illumination variability. The synthetic images are generated using physically based rendering (PBR) engines to simulate controlled lighting setups, complex geometries, and shadow interactions that are difficult to capture in natural datasets. Additionally, the dataset undergoes extensive augmentation, including exposure jitter, hue variation, color temperature shifts, and simulated noise injection. These augmentations enhance robustness and mitigate overfitting by exposing the model to a wide range of possible lighting distortions. The overall training process applies per-sample weighting schemes to emphasize rare or underrepresented shadow scenarios, such as faint diffused shadows in overcast conditions.

In an embodiment of the present disclosure, the shadow detection model 110 includes specialized architectural enhancements for multi-scale feature extraction to preserve both global boundary coherence and local edge detail. The model’s final prediction layer outputs temperature-scaled softmax probabilities that are calibrated using statistical techniques such as Platt scaling or isotonic regression on a dedicated calibration set. The probability calibration ensures that the predicted confidence scores accurately reflect the true likelihood of shadow presence, improving interpretability and downstream harmonization stability.

The detection module 212a detects one or more shadow regions within the image of the physical environment based on the generated depth map and extracted features. In an embodiment, the detection module 212a applies a shadow-detection model 110 trained to identify shadow regions using spatial, photometric, and textural patterns. The term shadow region refers to a contiguous set of pixels exhibiting reduced luminance due to light occlusion by an object. The detection module integrates depth cues to distinguish true shadows from dark object textures by verifying consistency between geometric occlusion and luminance drop. The module outputs an initial shadow-likelihood map that marks probable shadow areas for refinement in subsequent processing stages.

The detection module 212a acts as the primary inference interface that operationalizes the trained shadow detection model 110. While the model itself defines the learned parameters and neural architecture, the detection module 212a serves as the runtime component responsible for feeding input tensors, executing inference cycles, processing the predicted outputs, and generating pixel-level detections of shadow regions. The detection module 212a receives the unified tensor produced by the generation module 210, which includes depth maps, photometric features, spatial geometry representations, and contextual encodings.

Upon receiving the input tensor, the detection module 212a performs input normalization to align pixel intensity distributions with the intensity distributions used during model training. The normalization process ensures consistency between the live inference data and the model’s learned feature space. The module then invokes the forward-pass execution of the shadow detection model 110. During The process, the module feeds the input tensor through multiple computational layers, including convolutional encoders, attention-based transformer modules, and upsampling decoders, all operating under the direction of the trained neural weights stored in the system 108 memory.

In an embodiment of the present disclosure, the detection module 212a utilizes multi-scale inference strategies to balance speed and precision. The term multi-scale inference refers to the process of analyzing the same image at multiple resolutions to detect shadows of varying sizes and contrasts. Lower-resolution inputs capture large, soft shadows that span wide spatial areas, while higher-resolution inputs reveal finer, sharper boundaries cast by smaller objects. The detection module 212a merges predictions from these multiple scales using non-linear blending or confidence-based weighting, resulting in an output shadow probability map that is robust to variations in object size, light intensity, and viewing distance.

The detection module 212a performs adaptive thresholding on the output logits produced by the shadow detection model 110 to generate binary shadow masks. The term logit refers to the raw, unnormalized score output by the final layer of a neural network prior to the softmax activation. The module applies a sigmoid or softmax function to transform logits into probability values between 0 and 1. A context-dependent threshold, dynamically adjusted based on illumination variance, is then applied to classify pixels as either “shadow” or “non-shadow.” The adaptive mechanism allows the system to remain stable across different brightness levels and lighting conditions, ensuring that neither overly aggressive nor overly conservative thresholding produces false detections.

In an embodiment of the present disclosure, the detection module 212a executes temporal smoothing when consecutive frames are available. Temporal smoothing mitigates flicker artifacts in video-based mixed reality applications. The module compares pixel-level predictions across sequential frames using optical flow and IMU data alignment to maintain temporal consistency. When abrupt changes are detected, such as sudden shadow displacement due to transient light sources, the module employs exponential moving averages or Kalman filtering to stabilize predictions over time.

In addition to producing binary shadow masks, the detection module 212a computes confidence maps for each detected shadow region. A confidence map quantifies the likelihood that a particular pixel truly represents a shadow based on the network’s probabilistic output and internal feature activations. These maps are particularly valuable for downstream modules such as the mask generation module 212b, which rely on per-pixel confidence weighting for refining segmentation boundaries. The detection module 212a performs post-processing such as morphological filtering to remove isolated noise pixels and enforces spatial coherence by applying connected-component analysis.

For example, when the system analyzes a live camera feed of an outdoor parking area during sunset, the detection module 212a identifies elongated shadows cast by vehicles and lamp posts. By analyzing local gradient direction, the module recognizes that the shadows follow a consistent angular alignment relative to the sun vector. The detection module 212a applies adaptive thresholding to account for reduced luminance contrast as ambient light changes, maintaining consistent segmentation even as illumination intensity decreases.

In an embodiment of the present disclosure, the detection module 212a includes subroutines that classify detected shadows into distinct categories, including hard shadows and soft shadows, corresponding to dependent claims. Hard shadows are characterized by abrupt luminance transitions and minimal penumbra regions, typically produced under strong directional light sources such as direct sunlight. Soft shadows, in contrast, exhibit gradual luminance transitions and blurred boundaries, resulting from diffused or multiple light sources. The detection module 212a computes gradient entropy and boundary slope metrics across detected regions to assign each shadow region to a corresponding category. The categorization supports adaptive harmonization of lighting effects for digital objects in subsequent stages.

The detection module 212a interfaces with the classification module 212c for secondary validation of its output. The detection module 212a transmits both the binary mask and confidence map for context-aware re-evaluation. The modular interlinking ensures that shadow regions incorrectly classified due to reflective surfaces, ambient light fluctuations, or material textures can be reprocessed and corrected without requiring complete re-inference.

In an embodiment of the present disclosure, the detection module 212a is configured to operate under edge-computing and cloud-assisted environments. In edge mode, the detection process executes directly on the user device 104 using optimized, quantized model weights that minimize computational overhead. In cloud-assisted mode, the module transmits input tensors to remote servers hosting full-precision models, enabling high-fidelity inference for enterprise-grade applications. The system 108 dynamically switches between these modes depending on network latency, processing availability, and device capability.

The mask generation module 212b generates a shadow mask corresponding to the detected one or more shadow regions within the image of the physical environment. In an embodiment, the mask generation module 212b performs binary segmentation of the shadow-likelihood map, producing a two-dimensional mask in which each pixel is labeled as “shadow” or “non-shadow.” The term mask refers to a pixel-wise logical representation that isolates regions of interest for subsequent processing. The module may employ morphological operations such as dilation or erosion to refine mask boundaries and eliminate noise artifacts. The generated mask provides a clean, spatially accurate representation of shadow regions aligned with scene geometry.

The mask generation module 212b operates as the refinement and synthesis component that converts the probabilistic outputs of the detection module 212a into high-precision, topologically consistent segmentation masks. The term shadow mask refers to a pixel-wise binary or grayscale representation indicating the extent and confidence of shadow regions within an image. Each pixel value in the mask represents the likelihood of that pixel being part of a shadow, typically normalized between 0 and 1. The module performs both spatial and temporal refinements to ensure that the generated mask maintains structural coherence, edge precision, and temporal stability across frames.

Upon receiving the shadow probability map and confidence map from the detection module 212a, the mask generation module 212b first aligns the data with geometric and depth information derived from the generation module 210. The alignment ensures that shadow boundaries correspond precisely with the underlying physical surfaces in the scene. The module performs depth-constrained boundary refinement, a process in which the shadow edges are adjusted to align with depth discontinuities or surface transitions detected in the scene. The step prevents shadows from being misaligned with real-world geometry, particularly on complex surfaces like curved walls or uneven terrain.

The module applies confidence-weighted smoothing to integrate per-pixel probabilities into coherent regions. Confidence weighting refers to the use of reliability scores, provided by the detection module 212a, to prioritize stable predictions and suppress uncertain regions near object edges or under low illumination. The smoothing is performed using guided filtering or anisotropic diffusion methods, which preserve edge sharpness while reducing pixel-level noise. For example, when a detected shadow overlaps partially reflective surfaces such as a glass table, the mask generation module 212b uses confidence weighting to retain strong detections on opaque surfaces and attenuate uncertain detections on transparent or specular areas.

In an embodiment of the present disclosure, the mask generation module 212b employs region-growing segmentation guided by gradient and chromaticity cues to expand incomplete shadow regions. The region growing refers to an image segmentation process that starts from high-confidence seed points and iteratively includes neighboring pixels that exhibit similar luminance and color characteristics. The process allows the module to fill gaps in detected shadows that may have been fragmented by partial occlusions or noise.

In another embodiment of the present disclosure, the mask generation module 212b integrates temporal coherence filtering to maintain consistency across consecutive frames in video-based mixed reality applications. Temporal coherence ensures that the shadow mask for the same physical region does not flicker or shift unexpectedly over time. The module computes inter-frame correspondences using optical flow and device motion data obtained from the IMU sensor. When discrepancies arise between consecutive frames, the module applies a temporal blending factor to smooth out abrupt transitions while preserving the responsiveness of the shadow boundaries to real lighting changes.

The mask generation module 212b performs semantic reconciliation by leveraging the outputs of the classification module 212c, which provides contextual information about shadow types (for example, hard versus soft shadows). The module adjusts edge gradients and feathering profiles accordingly. For hard shadows, the module sharpens edges using edge-preserving filters to emphasize crisp boundaries consistent with directional light. For soft shadows, the module applies Gaussian blending or gradient falloff adjustments to mimic natural penumbra transitions. The adaptation aligns the generated masks with the physical lighting characteristics of the environment, improving the realism of rendered digital content in subsequent harmonization stages.

In an embodiment of the present disclosure, the mask generation module 212b uses conditional random fields (CRF) or graph-based refinement models to enhance spatial consistency within the mask. The probabilistic graphical models treat each pixel as a node and establish pairwise relationships based on color similarity, spatial proximity, and confidence scores. The CRF optimization minimizes an energy function balancing local pixel evidence and neighborhood smoothness, resulting in visually coherent, edge-aligned shadow regions. The output of The refinement is a high-resolution mask that accurately captures both primary and secondary shadow boundaries.

For example, when the system analyzes an indoor scene with both direct and reflected light, the detection module 212a identifies multiple overlapping shadow candidates. The mask generation module 212b refines these detections by merging overlapping segments and enforcing depth coherence, resulting in separate masks for primary shadows cast by direct lighting and secondary shadows produced by reflections. The masks, once finalized, form the structural foundation for geometric interpretation and illumination modeling performed in later modules.

The classification module 212c classifies the detected shadow regions into one or more shadow types based on luminance, softness, and edge gradients. In an embodiment, the classification module 212c assigns each detected shadow to categories such as hard shadow, soft shadow, or self-shadow. The term hard shadow refers to a sharply defined region created by a direct light source, while soft shadow indicates a diffused boundary produced by scattered illumination.

The classification module 212c classifies, using the shadow detection outputs received from the mask generation module 212b, the type of lighting condition in the physical environment based on the detected one or more shadow regions. The classification module 212c operates as the interpretive component of the shadow-analysis system 108 that transforms the refined shadow masks into semantically meaningful lighting-context labels. The module determines whether the scene is characterized by a first-type illumination, representing dominant directional lighting that produces discrete and sharply bounded shadows, or a second-type illumination, corresponding to diffused or ambient lighting that yields soft, faint, or non-distinct shadows.

Upon receiving the refined shadow masks and associated confidence maps from the mask generation module 212b, the classification module 212c computes statistical and geometric descriptors that quantify the spatial and photometric behavior of the detected shadows. The descriptors include, but are not limited to, shadow area ratios, mean luminance contrast between shadowed and illuminated pixels, edge sharpness gradients, and directional coherence of local luminance transitions. The module employs convolutional neural networks (CNNs) and gradient-based analytical functions to derive these features. The CNN architecture extracts higher-level representations such as texture continuity and intensity uniformity, while gradient-based heuristics measure local light intensity falloff and chromatic stability across shadow edges. The combination of learned and deterministic cues ensures that classification performance remains robust across both natural and synthetic illumination conditions.

In an embodiment of the present disclosure, the classification module 212c processes aggregated region descriptors derived from each mask, including the centroid, principal axis, average depth, and edge sharpness metrics. The descriptors are combined into feature vectors representing the global illumination characteristics of the scene. The module then executes a lightweight fully connected neural network or transformer-based attention head over these vectors to infer the illumination class. The transformer head refers to a compact attention mechanism that weighs contributions from different shadow regions in proportion to their spatial and intensity significance. Accordingly, the module prioritizes dominant light directions or significant occlusion patterns and minimizes the influence of noise or secondary reflections.

In another embodiment of the present disclosure, the classification module 212c utilizes depth and geometry correlations to reinforce the accuracy of scene interpretation. The module analyzes the relative depth variations between shadowed and illuminated regions to estimate the distance between occluders and surfaces. Shallow depth variation with sharp edges is indicative of near-surface occlusion under point lighting, whereas large depth variation with diffuse transitions suggests volumetric or ambient lighting. These geometric correlations are essential for distinguishing between artificial indoor lighting, where multiple localized sources overlap, and natural outdoor illumination dominated by the sun.

The module computes a shadow-edge sharpness index by evaluating the gradient magnitude along the perimeters of detected shadows. A high edge-sharpness score indicates strong directional lighting and crisp boundary definition, corresponding to first-type scenes. Conversely, a low score, combined with gradual intensity falloff, signals second-type diffused illumination. The module integrates these computed metrics into a classification decision model that outputs both the scene type and confidence values for each prediction. These confidence values are later stored in the database 112 to enable adaptive thresholding and retraining cycles based on observed environmental variability.

In an embodiment of the present disclosure, the classification module 212c distinguishes between indoor and outdoor environments by analyzing the variance of global lighting intensity, the angular distribution of detected shadows, and color-temperature cues derived from the image metadata. For instance, a predominance of warm color temperatures (around 2700 K to 3500 K) with multiple overlapping shadows typically corresponds to indoor artificial lighting, while higher color temperatures (above 5500 K) with unidirectional shadows indicate outdoor sunlight-dominated scenes. The module uses these cues to select between light estimation pipelines, either a mathematical vector estimation routine for single-source outdoor conditions or an HDRI-based environment map generation for multi-source indoor conditions.

In another embodiment of the present disclosure, the classification module 212c incorporates temporal aggregation for real-time mixed reality applications. The module analyzes sequences of classified frames to ensure continuity of scene interpretation over time. If illumination classification fluctuates rapidly between types across consecutive frames, the module applies temporal smoothing or weighted averaging based on the stability of the shadow features. The temporal smoothing or the weighted averaging prevents abrupt rendering changes in downstream harmonization stages and ensures consistent lighting perception for the user.

The estimation module 214 estimates, using the shadow detection model 110 and the generated depth map from the generation module 210, a direction and intensity of a light source present in the physical environment. The estimation module 214 functions as the analytical core of the shadow-analysis system 108 that interprets the geometric and photometric evidence obtained from preceding modules to infer the spatial origin, vector orientation, and radiometric strength of active light sources. The module translates visual cues embedded in the detected shadows, such as directionality, length, and softness, into numerical estimates representing the illumination conditions governing the physical environment. These illumination parameters are essential for ensuring that digital objects in mixed-reality (MR) environments exhibit lighting that matches the real-world context.

The light-source direction refers to a three-dimensional vector that originates from the light source and terminates at the point of illumination on the object or surface. The light-source intensity denotes the quantitative radiometric measure of luminous power emitted or reflected per unit area, typically expressed in lux or candela per square meter. The estimation module 214 computes both these attributes by analyzing shadow geometry, luminance gradients, and depth-based spatial relationships derived from prior modules.

Upon receiving inputs from the shadow detection model 110, the estimation module 214 identifies the relative position between shadow-casting objects and their corresponding shadow projections on illuminated surfaces. The estimation module 214 uses the tip-to-tip relationship between an occluder and occluder’s shadow, a geometric construct in which a line drawn from the tip of an object through the tip of the shadow approximates the direction of the light source vector. The module calculates the vector for multiple shadow instances within the frame and derives a weighted average direction based on confidence scores associated with each shadow region.

In an embodiment of the present disclosure, the estimation module 214 employs a geometric light vector regression method that fits a best-fit light vector through a least-squares optimization process. The optimization minimizes the angular discrepancy between observed and predicted shadow orientations under the current geometric model. The module leverages the three-dimensional depth coordinates generated by the generation module 210 to determine parameters, such as occluder height, surface inclination, and shadow offset distance. The determined directly relate to light elevation and azimuth angles. The process allows the system 108 to estimate the light-source direction even under partial occlusion or fragmented shadow visibility.

In another embodiment of the present disclosure, the estimation module 214 computes the light intensity by performing pixel-level luminance analysis within shadow and non-shadow regions. The module samples corresponding regions from the RGB image and computes mean luminance differences to determine illumination contrast. The ratio between the average brightness of illuminated pixels and the average brightness of shadowed pixels provides an empirical measure of the light-source intensity. The module refines thie estimation by accounting for material reflectance and camera exposure parameters available in the image metadata. For example, in an indoor workspace with diffused fluorescent lighting, the module observes low contrast between illuminated and shaded areas, to infer low directional intensity and broad diffusion of the light field.’

In an embodiment of the present disclosure, the estimation module 214 incorporates a deep illumination estimation network trained to predict lighting parameters directly from image features and shadow geometry. The network is trained on synthetic and real-world datasets containing images annotated with corresponding light direction vectors and intensity values. The training process employs a composite loss function combining angular loss (for directional accuracy) and photometric loss (for intensity matching). The angular loss penalizes deviations between predicted and ground-truth light directions, while the photometric loss enforces brightness consistency with real illumination conditions. The network receives as inputs the shadow mask, depth map, and the classification label (first-type or second-type illumination), allowing the system 108 to handle both hard and diffused lighting environments.

The estimation module 214 estimates light diffusion characteristics by analyzing edge gradients of the shadow mask. A sharp transition from dark to light indicates low diffusion and a concentrated light source, while gradual transitions suggest a broader or multiple light- source configuration. The module quantifies diffusion through a gradient entropy metric that measures the rate of luminance change across the shadow boundary. The entropy metric assists in determining whether the scene contains a single directional source, multiple point sources, or a spatially uniform ambient component.

For instance, in an outdoor environment where the sun gradually shifts position, the estimation module 214 continuously recalculates the light vector over successive frames. The temporal tracking ensures that digital objects rendered in the MR view adjust their shading and shadow orientation progressively rather than abruptly, preserving the perceptual realism of the mixed-reality experience

The geometry generator module 216 generates geometric relationships between the occluding object, the shadow region, and the corresponding light source. In an embodiment, the geometry generator module 216 computes occluder–shadow alignment by analyzing the relative position of objects and shadow boundaries using the depth map. The term occluder refers to an object obstructing light, causing the formation of a shadow. The module calculates geometric vectors representing the path of light from the occluder to the shadow terminus, allowing derivation of illumination direction and incident angles. These geometric correlations are critical for constructing accurate lighting models of the physical environment.

The geometry generator module 216 generates, based on the refined shadow mask obtained from the mask generation module 212b and the classification output from the classification module 212c, a geometric representation of the physical environment. The geometric representation includes surfaces, occluders, and spatial relationships relevant to the detected shadow regions.

The geometry generator module 216 acts as the spatial reconstruction core of the shadow-analysis system 108. The geometry generator module 216 interprets two-dimensional shadow masks and depth data to build a three-dimensional geometric model of the physical environment. The module infers the arrangement, shape, and orientation of real-world objects responsible for producing shadows, as well as the surfaces upon which those shadows are cast. The geometric representation forms the essential foundation for accurately estimating light direction, intensity, and diffusion characteristics in subsequent stages of illumination analysis and mixed-reality harmonization.

The geometry generation refers to the process of deriving spatial structure and surface topology from image and depth data. The geometry generator module 216 receives as input the refined shadow mask, the corresponding depth map, and the scene-type classification metadata. Using The data, the module first identifies occluders, objects that obstruct light and cast shadows, and receivers, surfaces where the shadows fall. The module segments these elements by cross-referencing shadow boundaries with discontinuities in depth and surface-normal vectors. Regions with significant depth discontinuity near a shadow edge are labeled as occluder boundaries, and relatively planar regions receiving shadows are labeled as receivers.

In an embodiment of the present disclosure, the geometry generator module 216 constructs a shadow-aware depth map that integrates depth and shadow cues into a unified spatial representation. The module refines the original depth map from the generation module 210 using boundary information from the shadow mask to enhance geometric precision along occlusion edges. The process includes gradient-guided depth refinement, where the module aligns depth discontinuities with shadow contours to improve realism in 3D reconstruction. The refined map supports subsequent estimation of light vectors by ensuring that shadow geometry and scene topology remain physically consistent.

The geometry generator module 216 employs multi-view spatial fusion when multiple frames or camera viewpoints are available. Multi-view fusion refers to the process of combining depth data from different perspectives to form a dense and continuous three-dimensional model. The module uses structure-from-motion (SfM) or simultaneous localization and mapping (SLAM) techniques to align and merge partial reconstructions. The fusion process allows the module to maintain coherent shadow geometry even when objects move or when the user device 104 captures the scene from varying angles. The fused geometry assists in identifying repeating occlusion patterns and reconstructing volumetric features like tree branches, railings, or window grids that cast complex shadows.

In another embodiment of the present disclosure, the geometry generator module 216 computes surface normals and plane equations for each region of the scene. The term surface normal denotes a perpendicular vector to a surface at a specific point and is crucial for determining how light interacts with that surface. The module estimates surface normals from depth gradients and validates them using photometric consistency constraints. For example, when analyzing an outdoor courtyard, the module determines that ground planes have horizontally oriented normals, while vertical structures like poles or walls have perpendicular normals. These calculated normals enable accurate estimation of how light rays strike and scatter across the scene.

The module generates occluder geometry meshes representing the objects responsible for shadow formation. These meshes are constructed using triangulation of the occluder’s depth contour and stored as lightweight 3D models. The term mesh refers to a collection of vertices, edges, and faces that define the shape of a 3D object. The module optimizes these meshes by applying Laplacian smoothing and adaptive decimation to reduce computational complexity while preserving structural fidelity. The 3D occluder geometry serves as a key input to the estimation module 214 for determining light-source positioning through shadow projection analysis.

In an embodiment of the present disclosure, the geometry generator module 216 applies inverse shadow projection to validate reconstructed geometry. Inverse shadow projection refers to the process of back-tracing light rays from detected shadow regions through the reconstructed scene geometry to approximate potential light-source positions. By comparing projected intersections with known occluder boundaries, the module verifies geometric accuracy and corrects inconsistencies. For example, if a reconstructed occluder casts a shadow inconsistent with the observed shadow mask, the module adjusts the occluder’s position or orientation until geometric and photometric alignment is achieved.

In another embodiment of the present disclosure, the geometry generator module 216 employs an AI-based geometric completion network to fill missing depth regions that arise from reflective or transparent materials where direct depth sensing fails. The network is trained on large-scale synthetic datasets containing paired RGB and depth images. The network predicts plausible geometric structures in occluded regions based on contextual cues such as neighboring surfaces and shadow continuity. The inclusion of AI-driven geometric completion ensures that the reconstructed 3D environment remains complete and physically meaningful, even when partial sensor data is unavailable.

The geometry generator module 216 generates a geometry confidence map that quantifies the reliability of each reconstructed region. The confidence map incorporates error metrics such as reprojection error, depth variance, and normal consistency. Regions with low confidence are flagged for reprocessing or exclusion from light-source estimation to prevent propagation of geometric inaccuracies.

For example, when the system analyses an indoor laboratory illuminated by multiple ceiling lamps, the geometry generator module 216 identifies occluders such as microscopes, chairs, and instruments that obstruct the light. The geometry generator module 216 reconstructs the geometric outlines and the planar surfaces on which shadows appear, such as tables or walls. By aligning shadow masks with depth discontinuities, the module builds an accurate 3D representation that reveals how light travels through the space, enabling precise downstream calculation of light vectors and intensities.

The score calculation module 218 calculates a confidence score representing a probability value indicative of a likelihood of correct scene classification and accurate light estimation, based on the probability distribution output generated by the shadow detection model 110. The score calculation module 218 calculates the confidence scores associated with the classification and the estimation outcomes. In an embodiment, the score calculation module 218 evaluates reliability metrics such as model confidence, classification probability, and temporal consistency across frames. The term confidence score denotes a numerical index indicating certainty of model inference. The module computes these scores using ensemble averaging, Bayesian uncertainty estimation, or statistical variance analysis. The calculated scores guide adaptive system behavior, such as fallback to deterministic algorithms when confidence drops below pre-defined thresholds.

The score calculation module 218 determines how confident the system is in the correctness of the detected shadow regions, the classified illumination type, and the estimated lighting parameters. The module translates probabilistic outputs from multiple neural-network components, such as the shadow detection model 110, the classification module 212c, and the estimation module 214, into a single normalized confidence measure. The confidence score directly governs how the system 108 weights its analytical results during harmonization, ensuring that only sufficiently reliable data influence rendering decisions in mixed-reality environments.

The term confidence score refers to a numerical value, typically within a 0 to 1 range, which quantifies the statistical certainty of a given inference. A higher score indicates stronger agreement between the model’s internal predictions and the observed input features. The score calculation module 218 computes the metric by evaluating the output probability distribution obtained from the final softmax or sigmoid activation layers of the neural networks. The module applies temperature-scaled softmax calibration to adjust probability sharpness and prevent over-confident predictions. The scaling ensures that the numeric probabilities align with empirical accuracy levels observed during validation.

In an embodiment of the present disclosure, the score calculation module 218 fuses confidence estimates from different modules through a Bayesian evidence aggregation framework. Under the framework, each module contributes a likelihood estimate, shadow detection confidence, illumination classification confidence, and light-vector reliability, and the module computes a combined probability representing overall certainty. The Bayesian fusion accounts for uncertainty correlation across modules and prevents isolated low-confidence outputs from disproportionately reducing the overall reliability score.

The module may generate spatial confidence maps corresponding to per-pixel reliability across the shadow mask and depth map. The spatial confidence map is derived from intermediate activation variances and entropy measurements of the neural network’s output tensors. Entropy-based confidence estimation measures the unpredictability of a model’s predictions, lower entropy corresponds to higher certainty. The module uses these pixel-level confidence values to weight downstream harmonization parameters, so that regions with high reliability receive stronger influence in relighting and rendering.

In an embodiment of the present disclosure, the score calculation module 218 incorporates a temporal stability analysis to ensure consistent confidence estimation over sequential frames. The module compares current confidence values with exponentially weighted averages of prior frames and penalizes sudden confidence fluctuations caused by transient noise or motion blur. The temporal stabilization allows the mixed-reality rendering pipeline to adapt smoothly without perceptual flicker or sudden lighting inconsistencies.

For example, in an outdoor street scene where passing vehicles briefly block sunlight, the shadow detection confidence temporarily decreases. The score calculation module 218 recognizes the short-term drop as a transient anomaly and stabilizes the overall confidence score using temporal weighting, preventing unnecessary reclassification or recalibration of the light source.

In another embodiment of the present disclosure, the module outputs the final confidence score along with supporting diagnostic data, such as per-module confidence breakdowns, calibration coefficients, and model-uncertainty indices. The data is stored in the database 112 and transmitted to the output module 220, enabling transparent confidence propagation throughout the system.

The output module 220 outputs scene classification data. The scene classification data includes at least one of the detected shadow type, the direction of the light source, the intensity of the light source, and the confidence score computed by the score calculation module 218. The output module 220 packages, formats, and transmits the processed illumination parameters and reliability metrics to other components of the mixed-reality ecosystem, such as the rendering engine or harmonization subsystem. The output module 220 encodes these packets in interoperable formats such as JavaScript Object Notation (JSON) or Extensible Markup Language (XML), ensuring compatibility with device-side software, cloud-based harmonization servers, or cross-platform MR engines. Each packet includes unique identifiers, timestamps, and scene metadata (for example, camera pose, exposure settings, and geographic coordinates) to maintain contextual traceability of the output.

In an embodiment of the present disclosure, the output module 220 integrates an adaptive data-prioritization mechanism that dynamically adjusts the volume of transmitted data based on network bandwidth and latency conditions. When high-bandwidth connectivity is available, the module transmits complete illumination maps and per-pixel confidence data. Under constrained conditions, the module transmits compressed representations containing only aggregated scene-level illumination parameters. The adaptivity ensures that real-time performance remains unaffected even in mobile or wireless scenarios.

In an embodiment of the present disclosure, the output module 220 supports multi-user synchronization in collaborative MR environments. When multiple user devices share the same physical space, the module ensures that all devices receive harmonized illumination parameters through synchronized timestamps and lighting profiles. The synchronization guarantees that virtual objects appear consistently lit across different viewpoints and users.

For example, in a multi-user architectural visualization session, the output module 220 transmits a unified light-vector map and intensity distribution to all connected devices. Each user’s display system applies the same illumination data to render the virtual structure with identical lighting conditions, creating a seamless shared-reality experience.

In an embodiment of the present disclosure, the system 108 outputs the scene-classification data that directly triggers the activation of an appropriate rendering or harmonization pipeline. The output module 220 maps each classification outcome to a pre-defined pipeline descriptor corresponding to a specific rendering mode. For the first-type scenes characterized by the directional illumination, the module selects deterministic shadow-mapping routines that emphasize sharp boundary reproduction. For the second-type scenes representing the diffused or the ambient illumination, the module selects high-dynamic-range-imaging (HDRI) probe–based relighting frameworks that account for multi-source scattering. The trigger embeds confidence thresholds derived from the score calculation module 218, allowing rendering engines to invoke fallback or blending routines when classification certainty falls below the required reliability level. The design ensures that downstream mixed-reality rendering remains both adaptive and photometrically coherent with environmental lighting conditions.

In an embodiment of the present disclosure, the system 108 supports simultaneous detection and classification of multiple shadow instances corresponding to several real or virtual objects present in the scene. The detection module 212a generates region proposals, each tagged with a unique instance identifier. The mask generation module 212b refines the per-instance regions using instance-aware segmentation networks that employ embedding heads or conditional convolution layers to preserve object-level separation. The classification and estimation modules subsequently compute individualized lighting hypotheses for each detected instance. The system 108 maintains an internal object registry that stores metadata such as the instance ID, bounding-box coordinates, centroid depth, last-seen timestamp, and motion-vector estimates. The registry applies predictive motion models to maintain object identity and shadow correspondence across sequential frames. The registry ensures temporal continuity and stable illumination tracking.

By way of example, in a scene depicting two people standing beside a table, the system 108 detects three separate shadow instances corresponding respectively to each person and to the table. The registry tracks each instance with its own trajectory, updates the associated geometric descriptors as motion occurs, and preserves temporal coherence in shadow interpretation. As the users or objects move, the corresponding shadows dynamically adjust in direction and intensity without losing identity linkage, ensuring that the composite mixed-reality representation remains perceptually stable and contextually accurate.

In an embodiment of the present disclosure, the system 108 concurrently classifies multiple shadow instances associated with multiple real or virtual objects. The system assigns independent classification pipelines to each instance whenever illumination conditions or occlusion geometry differ significantly among objects. The module then aggregates global illumination constraints obtained from all instances to maintain inter-shadow consistency and to prevent conflicting lighting solutions when shadows overlap or interact. The aggregation ensures that even in scenes with complex inter-reflections or intersecting shadow geometries, the final illumination field remains globally coherent and physically plausible.

In an embodiment of the present disclosure, the system 108 operates in a continuous streaming configuration for real-time video streams. Sequential frames enter the analysis pipeline as micro-batches processed in overlapping windows to minimize latency. The analysis module 208 computes incremental feature updates, and the shadow detection model 110 performs frame-wise inference conditioned on temporal priors learned from preceding frames. The database 112 maintains a short-term ring buffer of recent frame features and their corresponding outputs. The score calculation module 218 and the estimation module 214 access the ring buffer to preserve temporal coherence and stability in lighting estimation. The system 108 implements re-analysis triggers, such as immediate re-evaluation at higher resolution whenever mean-luminance change exceeds a pre-defined threshold (for example 20 percent). The re-analysis prevents propagation of stale lighting data during abrupt illumination shifts.

In an embodiment of the present disclosure, the system 108 continuously processes sequential image frames to maintain temporal coherence of detected shadows and illumination estimates. The system applies motion-compensation algorithms that align consecutive frames based on inertial-measurement-unit (IMU) data, performs ring-buffer comparisons to detect inconsistencies, and uses temporal-smoothing filters to suppress flicker. The continuous adaptation ensures that lighting transitions in mixed-reality visualization remain fluid and perceptually stable, even when environmental lighting changes rapidly or when the user device 104 moves through dynamically illuminated spaces.\

In an embodiment of the present disclosure, the system 108 supports bidirectional feedback channels between the rendering engine and the system 108. The feedback includes post-render metrics such as perceived illumination mismatch, color deviation, or visual-discrepancy scores for adaptive model fine-tuning. The continuous feedback refines the illumination estimation accuracy and improves the perceptual consistency of the rendered content across diverse devices and lighting environments. The feedback mechanism establishes a self-learning loop between the analysis system and the rendering pipeline, for enhancing long-term performance and user experience in dynamic mixed-reality applications.

In an embodiment of the present disclosure, the shadow detection model 110 undergoes continual retraining using a composite dataset that includes both real-world and synthetically generated imagery annotated for hard, soft, and self-shadow regions. The dataset incorporates diversity in object materials, light intensity, surface reflectance, and viewpoint angles to improve generalization. The model training uses supervised deep-learning techniques with pixel-wise annotation masks and loss functions such as focal loss and Dice coefficient to balance class disparities. Data augmentation operations including brightness jittering, gamma correction, and synthetic shadow blending expand the training corpus. The model retraining pipeline periodically incorporates new samples collected from deployed devices, ensuring that the system adapts to evolving environmental conditions, sensor capabilities, and lighting technologies over time.

In an embodiment of the present disclosure, the system 108 incorporates a resource-orchestration layer that manages compute allocation and scalability across heterogeneous hardware, including CPUs, GPUs, and dedicated accelerators such as TPUs or NPUs. The orchestrator continuously monitors module workloads, queue lengths, and latency metrics to identify bottlenecks and dynamically provision additional computational resources. In an embodiment of the present disclosure, the resource orchestrator employs predictive autoscaling algorithms trained on historical workload data to forecast periods of increased demand. The orchestrator pre-allocates compute nodes or virtual containers minutes before expected load peaks, to reduce initialization latency and maintaining continuous quality of service. The predictive models utilize metrics such as time-of-day usage patterns, user concurrency rates, and prior inference request histories to determine scaling behavior.

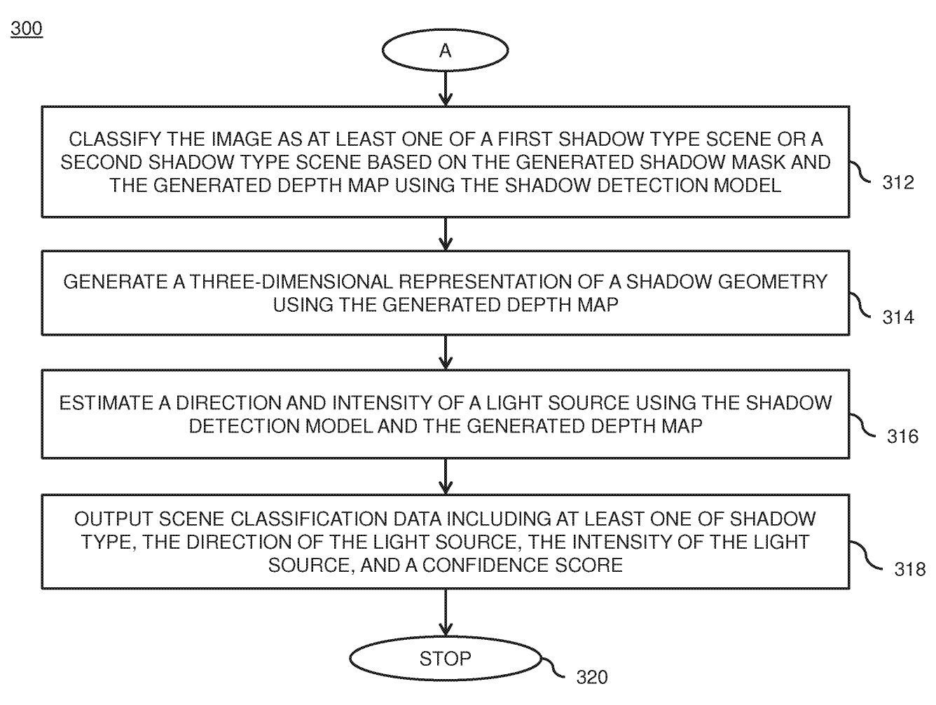

FIG. 3 illustrates a flowchart of a method 300 for detecting and classifying shadows in a physical environment in real time, in accordance with various embodiments of the present disclosure. It may be noted that the description of the flowchart 300 refers to FIG. 1 and FIG. 2, and the working and functioning may be read together with the descriptions thereof.

The flowchart 300 initiates at step 302. At step 304, the method includes receiving, from the user device 104, the one or more images of the physical environment. The one or more sensors 104a capture the one or more images. In addition, the one or more sensors 104a are embedded in the user device 104. In an embodiment of the present disclosure, the one or more sensors 104a include at least one of a camera, a depth sensor, a LiDAR unit, or a photometric sensor. The one or more sensors 104a capture visual, spatial, and illumination information representing the surrounding scene. The receiving module 206 processes the input to ensure integrity and synchronization of the frames, preparing the data for downstream analysis.

At step 306, the method includes generating the depth map of the physical environment based on the received image. The depth map represents the pixel-wise distance values between the imaging plane and the visible surfaces in the scene. When direct range data is unavailable, the generation module 210 employs the monocular-depth estimation model trained on the paired image–depth datasets to infer the relative depth from the single RGB frames. The generated depth map supports spatial understanding of object placement and assists in differentiating the cast shadows from dark material regions.

In an embodiment of the present disclosure, the method includes fusing the monocular depth estimation with the sparse absolute depth points obtained from LiDAR or stereo cameras. The monocular depth estimation is fused using the probabilistic sensor-fusion algorithm. The fusion aligns the relative and the metric scales and generates the dense, high-fidelity depth maps that enable precise three-dimensional reconstruction of shadow geometries.

At step 308, the method includes the detection of the one or more shadow regions in the received image using the shadow-detection model 110. The shadow-detection model 110 implements the deep-learning architecture combining convolutional and transformer layers. The deep learning models are trained to identify the photometric and the geometric features that differentiate the shadowed regions from the illuminated areas. The detection module 212a receives the pre-processed image and the corresponding depth map, performs the pixel-level segmentation, and outputs the initial shadow mask encoding per-pixel shadow probabilities.

In an embodiment of the present disclosure, the method includes refining the shadow mask using the mask generation module 212b. The refinement process employs the multi-scale feature extraction and the edge-aware filtering to preserve both the fine and the global shadow boundaries. The model is trained on the hybrid dataset. The hybrid dataset includes the annotated real and the synthetic images with the diverse lighting and the material variations. The training optimizes the composite loss combining Dice and focal terms to ensure high accuracy under challenging exposure and contrast conditions.

In an embodiment, the method includes analyzing the detected shadow mask and the generated depth map to compute the one or more illumination features. The one or more illumination features include at least one of the luminance distribution, the chrominance invariance, the edge-sharpness gradient, or the directionality vector field of the shadow. The analysis module 208 performs the spatial and the photometric analysis to identify the relationships between the objects, the surfaces, and the shadows within the reconstructed 3D scene.

At step 310, the method includes the generation of the depth map of the physical environment based on the image. In an embodiment, the generation module 210 computes per-pixel distance values that represent spatial geometry relative to the imaging plane. The depth map refers to the two-dimensional array in which each pixel intensity corresponds to an estimated distance from the camera to a surface point in the environment. The generation module 210 may use stereo disparity computation, structured-light projection, or monocular depth-estimation networks such as MiDaS for scenes lacking depth sensors. The generated depth map forms the geometric foundation for determining object boundaries, occlusions, and potential shadow regions.

At step 312, the method includes classifying the physical environment as at least one of the first shadow-type scene or the second shadow-type scene based on the one or more illumination features. The classification module 212c analyzes the homogeneity or the heterogeneity of the luminance distribution, the angular dispersion of the shadow vectors, and the color-temperature variance. The analysis is done to determine whether the illumination arises from the single directional source or the multiple diffuse sources. The first shadow-type scene corresponds to conditions dominated by direct light (for example, sunlight). The second shadow-type scene corresponds to the diffused or the ambient lighting conditions (for example, overcast sky or multiple indoor light sources).

In an embodiment of the present disclosure, the method includes determining the absence of the distinct shadow mask through the luminance-homogeneity. The method performs the gradient-entropy analysis to identify the second shadow-type scene. The uniform luminance combined with the high gradient entropy indicates the ambient illumination for prompting the classifier to categorize the environment as the second-type scene.

At step 314, the method includes estimating the one or more lighting parameters corresponding to the classified scene. The one or more lighting parameters include at least one of light-source direction, light-source intensity, diffusion coefficient, and color temperature. The estimation module 214 computes the parameters using the geometric relationships derived from the shadow orientation and the depth information for the first-type scene. Accordingly, the estimation module 214 employs the HDRI-based environment-map estimation for the second-type scene to approximate the global illumination fields.

In an embodiment of the present disclosure, the method includes computing the light-source intensity. The computation includes comparing the pixel-luminance averages between the illuminated and the shadowed regions after compensating for the exposure and the surface reflectance. The computed intensity provides the quantitative input for the downstream rendering engines to reproduce the accurate real-world brightness levels.

In an embodiment of the present disclosure, the method includes computing the light-direction vector. The computation includes connecting the coordinate of the occluding object’s reference point to the centroid of the corresponding shadow region in three-dimensional space reconstructed from the depth map. The geometry generator module 216 performs the computation and calculates the shadow-edge sharpness metric based on the luminance-gradient magnitudes across the mask boundary. The high gradient magnitude corresponds to the hard shadows caused by the directional illumination. The low magnitude indicates the diffused or the soft lighting conditions.

At step 316, the method includes calculating the confidence score that quantifies the reliability of the shadow detection, the classification, and the illumination estimation. The score calculation module 218 derives the confidence score from the probability outputs of the shadow-detection model 110 and the auxiliary indicators such as temporal stability and feature-map consistency. When the confidence score falls below the pre-defined threshold, the system 108 triggers re-analysis using adjusted parameters or alternative non-AI algorithms to ensure stable performance under constrained computational conditions.

In an embodiment of the present disclosure, the method includes computing the confidence score by applying a calibrated softmax function over the feature embeddings generated by the shadow-detection model 110, followed by weighting with temporal-stability coefficients derived from sequential-frame analysis. Accordingly, the computation processes leads to generating calibrated probability estimates that reflect overall reliability.

At step 318, the method includes outputting the scene classification data. The scene classification data includes at least one of the shadow type, the direction of the light source, the intensity of the light source, and the confidence score. In addition, the data includes the classified lighting data and the associated parameters to the rendering or the mixed-reality engine of the user device 104. The output module 220 formats the data into the standardized lighting descriptor. The lighting descriptor contains the shadow mask, the light vector, the intensity, the diffusion coefficient, and the confidence metrics. The output module 220 consumes the lighting descriptor to harmonize the digital objects with the real-world illumination.

In an embodiment of the present disclosure, the method includes triggering the automatic selection of the corresponding rendering pipeline on the user device 104 based on the output data. For the first-type scenes, the deterministic shadow mapping is activated. For the second-type scenes, the HDRI-probe relighting is initiated. The confidence thresholds determine whether the blended or the fallback lighting routines are executed to maintain the perceptual stability.

In an embodiment of the present disclosure, the method includes predicting the forthcoming illumination changes using the AI-based temporal convolutional network trained on the lighting-transition sequences. The predictive inference enables the pre-emptive adjustment of the parameters before visible lighting changes occur.

In an embodiment of the present disclosure, the method includes storing the processed lighting parameters and the metadata in the database 112 for the continual learning and system improvement. The database 112 maintains the versioned model weights, the illumination logs, and the annotated classification instances for retraining of the shadow-detection model 110 to enhance accuracy and robustness across diverse conditions.

The flowchart 300 ends at step 320. The described steps collectively enable the accurate, real-time detection, classification, and interpretation of the shadows and the lighting in the physical environments. The method improves visual realism, enhances illumination consistency, and ensures that virtual objects appear perceptually integrated within mixed-reality and augmented-reality applications.

The present disclosure is industrially applicable across multiple technological domains. In mixed-reality and augmented-reality platforms, the disclosed method provides the underlying illumination-analysis foundation for rendering virtual elements that visually align with physical environments. In film and visual-effects production, the method enables automated relighting and scene compositing based on real-world shadow analysis. In robotics and autonomous navigation, the method aids perception systems in distinguishing shadows from obstacles, improving decision reliability. In architecture, retail visualization, and industrial inspection, the method allows photometrically accurate simulations of lighting and shading conditions for design verification and product placement.

Accordingly, the present disclosure provides a robust computational framework that advances real-time environmental understanding, photometric analysis, and adaptive rendering essential for next-generation intelligent visualization systems. The present disclosure is industrially applicable in a wide range of technological fields involving environmental perception, photometric analysis, and mixed-reality rendering.

In the mixed-reality (MR), augmented-reality (AR), and extended-reality (XR) industries, the disclosed system 108 forms the analytical backend for lighting-aware rendering pipelines. The accurate detection of shadows enables real-time harmonization of digital elements with real-world illumination. For instance, virtual objects projected into a user’s environment exhibit realistic shading, contrast, and depth consistency when rendered based on shadow vectors and lighting parameters computed by the system 108.

In autonomous robotics and vehicle navigation, the disclosed system enhances environmental perception by distinguishing between shadows and tangible obstacles. The capability prevents false detections during path planning and ensures safe, context-aware navigation under dynamically changing illumination conditions such as tunnels, tree-lined roads, or flickering artificial lights.

In architectural visualization, interior design, and construction engineering, the system 108 facilitates photometrically accurate simulation of natural and artificial lighting. The real-time shadow analysis enables preview of façade shading, daylight penetration, and material reflectance behaviors before physical implementation. Such precision supports informed design decisions and sustainability assessments.

In the retail and e-commerce sector, the disclosed method 300 supports interactive visualization of products under realistic illumination conditions. Customers can virtually place objects such as furniture or décor within their actual environment, where the rendered product shadows dynamically adapt to ambient lighting, providing true-to-life previews that improve consumer confidence and engagement.

In industrial maintenance, inspection, and remote-assistance operations, the system 108 assists in overlaying diagnostic or procedural data onto machinery surfaces with correct lighting alignment. The ability to distinguish and adapt to real shadows prevents misalignment of visual overlays and ensures clarity of information under varying lighting conditions.

In education, scientific visualization, and training, the system 108 provides students and professionals with realistic mixed-reality demonstrations of optical phenomena, photometric modeling, and spatial analysis. The framework enables the study of illumination behavior, light-source orientation, and shadow formation through interactive, real-world simulations.

Furthermore, the modular architecture of the system 108 supports integration with edge-computing, cloud-processing, and distributed rendering infrastructures, ensuring scalability across consumer-grade and enterprise-level hardware ecosystems. The disclosed invention provides a technological foundation for next-generation visual-intelligence platforms, supporting industrial automation, digital-twin modeling, and intelligent environmental analysis.

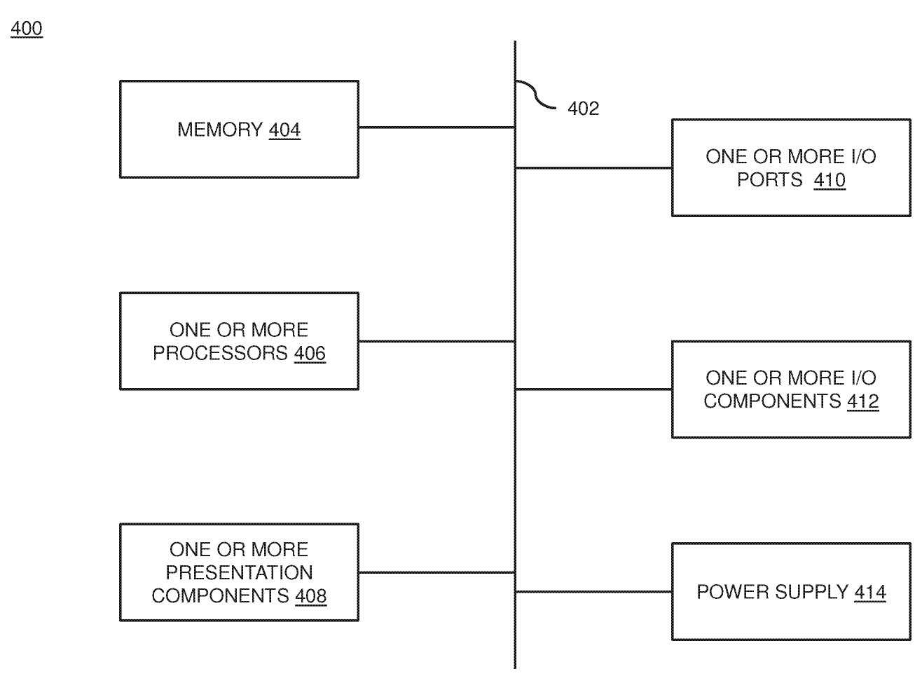

FIG. 4 illustrates a block diagram of an exemplary device 400 configured for executing the shadow detection and the classification operations in real time, in accordance with various embodiments of the present disclosure. The device 400 is representative of the user device 104 or any computing entity configured to operate the system 108, the shadow- detection model 110, and the associated analytical framework for the illumination estimation. The device 400 may be implemented as a non-transitory computer-readable storage medium storing instructions for the detection, the classification, and the interpretation of the shadows and the environmental lighting conditions of the physical environment in real time.

The device 400 includes a bus 402 that directly or indirectly couples a memory 404, one or more processors 406, one or more presentation components 408, one or more input/output (I/O) ports 410, one or more I/O components 412, and a power supply 414. The bus 402 represents one or more communication channels, such as an address bus, a data bus, or a combination thereof, enabling interaction among the components and supporting high-speed data transfer during real-time shadow analysis and illumination estimation.

In practice, boundaries between various components may overlap. For example, a processor 406 may incorporate embedded memory or an internal inference accelerator, while a display serving as a presentation component may act as an I/O interface for user interaction. FIG. 4 provides a logical representation of hardware elements that collectively enable the acquisition of sensor data, execution of the shadow-analysis algorithms, and transmission of lighting parameters for downstream rendering.

The device 400 includes one or more types of computer-readable media accessible to the processor 406. The computer-readable media may include volatile or non-volatile, removable or non-removable storage elements that maintain datasets, learned model parameters, and executable program instructions used by the shadow-detection and classification subsystems.

The computer-storage media may include random-access memory (RAM), read-only memory (ROM), flash memory, solid-state drives, magnetic or optical discs, or any equivalent medium capable of retaining data and program instructions. The communication media may embody data or instructions in a modulated data signal, such as a carrier wave transmitted through wired or wireless communication channels including Wi-Fi, 5G, Bluetooth, infrared, or satellite links. These channels facilitate seamless synchronization between the user device 104 and the system 108 for real-time inference.

The memory 404 stores computer-readable instructions that, when executed by the one or more processors 406, cause the device 400 to perform operations such as capturing environmental imagery, generating depth maps, executing the shadow-detection model 110, computing light vectors and intensity parameters, and transmitting the analytical output to the rendering pipeline. The memory 404 may include dedicated buffers for intermediate tensors, pre-processed illumination maps, and temporary confidence matrices generated during model inference.

The one or more processors 406 execute the instructions stored in the memory 404 to perform the computational operations required for shadow detection, segmentation, and classification. The processors 406 may include central processing units (CPUs) for control logic, graphics processing units (GPUs) for parallel image-matrix computations, digital signal processors (DSPs) for pixel-level filtering, and neural processing units (NPUs) or tensor cores optimized for executing the transformer-based segmentation and light-estimation models. In some embodiments, the processors 406 operate cooperatively to enable multi-threaded inference and ensure frame-rate-level responsiveness during continuous video capture.

The one or more presentation components 408 generate perceptible output for the user 102. Exemplary components include a display screen, a head-mounted display (HMD), or an augmented-reality headset that visualizes analyzed lighting data or renders virtual content aligned with detected illumination. Additional presentation components may include speakers or haptic modules that provide contextual feedback corresponding to illumination shifts or scene-classification results. The presentation components 408 enable the user to perceive lighting and shadow behavior as interpreted by the device 400 in real time.

The one or more I/O ports 410 facilitate communication between the device 400 and external systems, networks, or auxiliary sensors. Illustrative interfaces include USB-C, Thunderbolt, or HDMI ports for connecting external imaging modules or calibration tools. The I/O components 412 capture environmental and sensory data necessary for the shadow-analysis process. Such components include the RGB camera, depth sensor, LiDAR scanner, ambient-light sensor, photometric probe, microphone, or inertial-measurement unit (IMU). These collectively provide the visual, spatial, and illumination cues essential for constructing the physical environment and performing accurate shadow classification.

The power supply 414 provides electrical energy required for device operation. The power supply 414 may include a rechargeable lithium-ion battery for portable devices such as smartphones or AR glasses, or a wired AC/DC unit for stationary computing systems such as rendering servers or analytical workstations. In some embodiments, the power supply 414 employs dynamic voltage-and-frequency scaling to optimize energy consumption during model inference and idle processing cycles.

During operation, the processors 406, the memory 404, and the I/O components 412 function in a continuous feedback loop. The I/O components 412 acquire sensor data, which is streamed through the bus 402 to the memory 404. The processors 406 execute the shadow-detection model 110 to generate pixel-wise probability maps and lighting parameters. The results are subsequently transmitted to the presentation components 408 or to external rendering frameworks for lighting-aware content adaptation.

In some embodiments, the device 400 communicates with a remote shadow-analysis server or a cloud-based illumination-classification engine to offload computationally intensive tasks such as large-scale transformer inference or dataset retraining. The distributed configuration allows hybrid processing between local and remote resources, achieving scalability, bandwidth optimization, and consistent inference quality across heterogeneous user devices.

The arrangement of components shown in FIG. 4 is illustrative and not restrictive. Fewer or additional components may be incorporated depending on implementation requirements. Functional responsibilities described for one component may alternatively be distributed across multiple modules. The device 400 is representative of a flexible and scalable computing architecture capable of executing the real-time detection and classification of shadows, estimation of environmental lighting parameters, and delivery of illumination-consistent analytical outputs across diverse hardware and network infrastructures.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A system for detecting and classifying shadows in a physical environment in real time, the system comprising:
one or more processors; and
a non-transitory memory storing instructions, wherein the instructions, when executed by the one or more processors , cause the system to:
receive, from a user device, an image of a physical environment captured by one or more sensors;
generate a depth map of the physical environment based on the image of the physical environment;
detect, using a shadow detection model trained to generate a shadow mask for the image, one or more shadow regions in the image;
generate, using the shadow detection model, the shadow mask corresponding to the detected shadow regions;
classify, using the shadow detection model, the image as at least one of a first shadow type scene or a second shadow type scene based on the generated shadow mask and the generated depth map;
in response to the image being classified as the first shadow type scene:
generate a three-dimensional representation of a shadow geometry using the generated depth map; and
estimate, using the shadow detection model and the generated depth map, a direction and intensity of a light source; and
output to the user device or a downstream rendering system scene classification data comprising at least one of shadow type, direction of the light source, intensity of the light source, and a confidence score.

2. The system as claimed in claim 1, wherein the classification comprises analysing homogeneity or heterogeneity of light-ray distribution and luminance gradients across the physical environment to differentiate directional illumination from diffused illumination.

3. The system as claimed in claim 1, wherein the system estimates lighting parameters using a mathematical light-vector computation for directional illumination and an HDRI-based environment-map analysis for non-directional illumination.

4. The system as claimed in claim 1, wherein the system identifies indoor or outdoor illumination context based on lighting variance, shadow spread, and colour-temperature cues, and adjusts classification weighting based on the identified indoor or outdoor illumination context.

5. The system as claimed in claim 1, wherein the system processes sequential image frames and maintains temporal coherence of detected shadows to ensure consistent lighting adaptation in video sequences.

6. The system as claimed in claim 1, wherein the system simultaneously classifies multiple shadow instances corresponding to multiple real or virtual objects in the scene.

7. The system as claimed in claim 1, wherein the system outputs scene-classification data that triggers selection of a corresponding rendering or harmonization pipeline based on the determined illumination type.

8. The system as claimed in claim 1, wherein classifying the image as the second shadow type scene comprises determining an absence of the generated shadow mask by performing a luminance homogeneity analysis across the image and analysing an absence of directional gradients in detected luminance values.

9. The system as claimed in claim 1, wherein the shadow detection model is trained on a dataset of annotated synthetic images representative of different shadow conditions, wherein the training of the shadow detection model comprises:
extracting pixel-level luminance and chrominance features from the annotated synthetic images;
generating ground-truth shadow masks for the annotated synthetic images; and
optimizing model parameters based on a segmentation loss function that minimizes differences between predicted and ground-truth shadow masks, wherein the optimization comprises applying a multi-scale feature extraction strategy to preserve global shadow boundaries and fine-grained shadow details.

10. The system as claimed in claim 1, wherein the shadow detection model comprises a transformer-based segmentation network configured to perform pixel-level segmentation for generating the shadow mask.

11. The system as claimed in claim 1, wherein generating the depth map comprises estimating depth values using a combination of monocular depth estimation and a device-based spatial mapping framework configured for environmental depth estimation and coordinate anchoring.

12. The system as claimed in claim 1, wherein the estimating of the direction of the light source comprises computing a light vector from a tip of the detected shadow to a tip of a corresponding object in the three-dimensional representation of the scene, wherein the estimating of the intensity of the light source comprises calculating the intensity based on pixel-level luminance analysis of the detected shadow region.

13. The system as claimed in claim 1, wherein outputting the scene classification data comprises associating the data with a confidence score determined by a probability distribution output of the shadow detection model.

14. The system as claimed in claim 1, wherein the detecting of the one or more shadow regions comprises continuously receiving sequential frames from the user device (104) and dynamically updating the shadow mask for each frame.

15. The system as claimed in claim 1, wherein the classifying of the image comprises distinguishing between one or more static environmental parameters and one or more dynamic environmental parameters, wherein the one or more static environmental parameters comprise at least surface geometry and object positions, and the one or more dynamic parameters comprise lighting conditions and shadow regions.

16. The system as claimed in claim 1, comprising distinguishing, using the shadow detection model, one or more first scenes classified as the first shadow type scene caused by a single dominant light source from one or more second scenes classified as the second shadow type scene caused by multiple ambient light sources.

17. The system as claimed in claim 1, wherein the confidence score represents a probability value output indicating a likelihood of correct shadow type scene classification, wherein the confidence score is calculated by applying a softmax function over feature embeddings of the image, and the confidence score is used to determine a reliability threshold for accepting or rejecting the classification result.

18. A method for detecting and classifying shadows in a physical environment in real time, the method comprising:
receiving, from a user device, an image of a physical environment captured by one or more sensors ;
generating, using one or more processors, a depth map of the physical environment based on the image of the physical environment;
detecting, using a shadow detection model trained to generate a shadow mask for the image, one or more shadow regions in the image;
generating, using the shadow detection model, the shadow mask corresponding to the detected shadow regions;
classifying, using the shadow detection model, the image as at least one of a first shadow type scene or a second shadow type scene based on the generated shadow mask and the generated depth map; and
in response to the image being classified as the first shadow type scene:
generating a three-dimensional representation of a shadow geometry using the generated depth map;
estimating, using the shadow detection model and the generated depth map, a direction and intensity of a light source; and
outputting to the user device or a downstream rendering system, scene classification data comprising at least one of shadow type, direction of the light source, intensity of the light source, and a confidence score.

19. The method of claim 18, wherein classifying the image as the first shadow-type scene or the second shadow-type scene is performed by jointly evaluating the generated shadow mask and the generated depth map to distinguish directional illumination from diffused illumination based on spatial consistency of shadow boundaries relative to depth discontinuities in the physical environment.

20. A non-transitory computer-readable medium storing instructions that, when executed by one or more processors, cause a system to perform a method for detecting and classifying shadows in a physical environment in real time, the method comprising
receiving, from a user device, an image of a physical environment captured by one or more sensors;
generating, using one or more processors, a depth map of the physical environment based on the image of the physical environment;
detecting, using a shadow detection model trained to generate a shadow mask for the image, one or more shadow regions in the image;
generating, using the shadow detection model, the shadow mask corresponding to the detected shadow regions;
classifying, using the shadow detection model, the image as at least one of a first shadow type scene or a second shadow type scene based on the generated shadow mask and the generated depth map; and
in response to the image being classified as the first shadow type scene:
generating a three-dimensional representation of a shadow geometry using the generated depth map;
estimating, using the shadow detection model and the generated depth map, a direction and intensity of a light source; and
outputting to the user device or a downstream rendering system, scene classification data comprising at least one of shadow type, direction of the light source, intensity of the light source, and a confidence score.
